(19) United States
(12) Patent Application Publication
(10) Pub. No.: US 2007/0289693 A1
(43) Pub. Date: Dec. 20, 2007

(54) Thermoplastic resin compositions suitable for use in transparent laminates

(76) Inventors: Jerrel C. Anderson, Vienna, WV (US); Richard A. Hayes, Beaumont, TX (US); Steven C. Pesek, Orange, TX (US); John W. Paul, Beaumont, TX (US); C. Anthony Smith, Vienna, WV (US); Stephen J. Bennison, Wilmington, DE (US); Sam L. Samuels, Landenberg, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/454,057

(22) Filed: Jun. 15, 2006

(51) Int. Cl. B32B 27/30

(52) U.S. Cl. 156/99; 428/522; 524/556; 524/236; 156/285

(57) ABSTRACT

The present invention is an improved polymeric resin composition comprising units derived from ethylene, from about 20 wt % to about 30 wt % units derived from an α,β-unsaturated carboxylic acid having from 3 to 8 carbons, and optionally an effective amount of at least one additive selected from the group consisting of hindered amine light stabilizers, UV light absorbers, and thermal stabilizers. Resins of the present invention are particularly suitable for preparing transparent laminates useful as glazing elements that provide a greater measure of safety than non-laminated glazing elements.

### FIELD OF THE INVENTION

The present invention relates to transparent laminate articles. More specifically, the present invention relates to resin compositions suitable for use as an intermediate layer in transparent laminate articles.

### BACKGROUND OF THE INVENTION

Several patents and publications are cited in this description in order to more fully describe the state of the art to which this invention pertains. The entire disclosure of each of these patents and publications is incorporated by reference herein.

Glass laminated products have contributed to society for almost a century. Beyond the well known, every day automotive safety glass used in windshields, glass laminates are used in most forms of the transportation industry. They are utilized as windows for trains, airplanes, ships, and nearly every other mode of transportation. Safety glass is characterized by high impact and penetration resistance and does not scatter glass shards and debris when shattered. Glass laminates find widespread use in architectural applications, as well.

Safety glass typically consists of a sandwich of two glass sheets or panels bonded together with an interlayer of a polymeric film or sheet which is placed between the two glass sheets. One or both of the glass sheets may be replaced with optically clear rigid polymeric sheets such as, for example, sheets of polycarbonate materials. Safety glass has further evolved to include multiple layers of glass and/or polymeric sheets bonded together with interlayers of polymeric films or sheets.

A more recent trend has been the use of glass laminated products in the construction business for homes and office structures. The use of architectural glass has expanded rapidly over the years as designers incorporated more glass surfaces into buildings. Threat resistance has become an ever increasing requirement for architectural glass laminated products. Newer products are designed to resist both natural and man made disasters. Examples of these newer products include the recent developments of hurricane resistant glass, now mandated in hurricane susceptible areas, theft resistant glazings, and the more recent blast resistant glass laminated products designed to protect buildings and their occupants. These products have great enough strength to resist intrusion even after the glass laminate has been broken. For example, the newer products are designed to maintain their integrity when a glass laminate is subjected to high force winds and impacts of flying debris as occur in a hurricane or where there are repeated impacts on a window by a criminal attempting to break into a vehicle or structure.

In addition, glass laminated products have now reached the strength requirements for being incorporated as structural elements within buildings. An example of this is the glass staircases that are now being featured in many buildings.

The interlayer is typically made with a relatively thick polymer film or sheet that exhibits toughness and adheres to the glass in the event of a crack or crash. Over the years, a wide variety of polymeric interlayers have been developed to produce laminated products. In general, it is desirable that these polymeric interlayers possess acceptable levels of: optical clarity (haze of less than 4%), impact resistance, penetration resistance, ultraviolet light resistance, long term thermal stability, adhesion to glass and/or other rigid polymeric sheets, ultraviolet light transmittance, moisture absorption, moisture resistance, long term weatherability, among other characteristics. Widely used interlayer materials include complex multi-component compositions comprising polymers such as: polyvinylbutyral (PVB); polyurethane (PU); polyvinylchloride (PVC); metallocene-catalyzed linear low density polyethylenes; ethylene vinyl acetate (EVA); ethylene acid copolymer ionomers; polymeric fatty acid polyamides; polyester resins such as poly(ethylene terephthalate); silicone elastomers; epoxy resins; elastomeric polycarbonates; and the like. Acid copolymers have become more widespread in their use for fabricating transparent laminates.

U.S. Pat. No. 3,344,014 discloses laminated glass products with an ethylene copolymer ionomer interlayer. U.S. Pat. No. 3,404,134, discloses a process of ionically crosslinking certain copolymers which contain carboxylic acids. U.S. Pat. No. 4,663,228 and U.S. Pat. No. 4,668,574 each discloses a transparent laminated article which includes a water insoluble ionomer resin film comprising the metal salt of an ionomer resin prepared from ethylene and methacrylic acid monomers. U.S. Pat. No. 5,344,513 discloses a method for manufacturing a laminated transparent substrate which includes an ethylene copolymer ionomer interlayer. U.S. Pat. No. 5,759,698 discloses laminated glass which includes an interlayer comprising an ionomer resin of ethylene-methacrylic acid copolymer with a metal ion which has been thermoset with an organic peroxide and a silane coupling agent. U.S. Pat. No. 5,763,062, discloses a transparent article comprising an extruded ionomer resin film or sheet having a carboxylic acid content of between about 17 and 40 weight percent, said ionomer resin being essentially free of amines. U.S. Pat. No. 5,895,721 and U.S. Pat. No. 6,238,801 each discloses a glazing which includes a transparent layer of an ionomer resin with improved adhesion through the use of a metal chelate. U.S. Pat. No. 6,150,028 discloses glass laminates which include ionomer resin interlayers and glass with solar control characteristics. U.S. Pat. No. 6,187,845 discloses red shifted benzotriazole UV absorbers for use in adhesives for glass laminates. U.S. Pat. No. 6,191,199 discloses hydroxphenyl-s-triazine UV absorbers for use in adhesives for glass laminates. U.S. Pat. No. 6,268,415 discloses stabilized adhesive compositions which contain certain benzotriazole UV absorbers. U.S. Pat. No. 6,432,522, discloses optically transparent glazing which includes interlayers comprising ethylene methacrylic acid copolymers that incorporate 15 to 17 weight percent of the acids and that are partially neutralized with sodium. U.S. Patent Application No. 2002/0155302 discloses a method for preparing a transparent laminated article which includes an interlayer comprising a copolymer of an olefin with 13 to 21 weight percent of methacrylic or acrylic acid monomers partially neutralized with an alkali cation. U.S. Patent Application No. 2003/0044579 discloses a method for preparing a transparent laminated article which includes an interlayer comprising a copolymer of an olefin with 13 to 22 weight percent of methacrylic or acrylic acid monomers partially neutralized with an alkali cation. Intl. Patent Appln. Publn. No. WO 99/58334 discloses transparent laminates which comprise a polymer of ethylene and methacrylic acid or acrylic acid containing about 14 to 24 weight percent of the acid and having about 10 to 80 percent of the acid neutralized with a metallic ion. Intl. Patent Appln. Publn. No. WO 00/64670 discloses transparent laminates which comprise a polymer of ethylene and methacrylic acid or acrylic acid containing about 14 to 24 weight percent of the acid and having about 10 to 80 percent of the acid neutralized with a metallic ion. Intl. Patent Appln. Publn. No. WO 01/60604 discloses a laminated glazing that includes an infra-red reflecting film bonded between a ply of ionomer resin and a ply of a polymer material. Intl. Patent Appln. Publn. No. WO 2004/011755 discloses transparent laminates which comprise a polymer of ethylene and methacrylic acid or acrylic acid containing about 14 to 28 weight percent of the acid and having about 20 to 60 percent of the acid neutralized with a metallic ion.

While laminated glass products which incorporate copolyethylene ionomeric interlayers have met many of the ever increasing demands required by society, these demands require even further developments. The extended lifetimes of that glass laminates are being required to undergo in the marketplace are placing ever increasing demands on thermal and light stability of the polymeric material forming the interlayer and the glass laminate itself.

Another area of improvement for these copolyethylene ionomeric interlayers would be enhanced adhesion to the glass or rigid material in a laminate.

Conventional teaching suggests that one way to increase adhesion in an acid copolymer interlayer is to increase the acid content of the copolymer resin. There are problems with this approach, however. One problem is that high acid resins having acid content of greater than 20 wt % are not available commercially. Also, it is known that certain copolymer resins that have high acid content can have an increased tendency to self-adhere. This can make manufacture and processing of high acid resins difficult, or at least more costly as measures have to be taken to avoid product losses from self-adhesion. For example storing high acid resin in a refrigerated container, alternatively or in conjunction with the use of slip agents or antiblock additives, could be desirable.

Another problem with using higher acid resins than are commercially available is that it is well known that as adhesion properties increase, the impact toughness of the laminate can deteriorate. Therefore adhesion has heretofore been controlled to a level where the impact performance is acceptable. That is, a balance between adhesion and impact toughness in the laminate has been struck to obtain a commercially viable product offering. Generally this is accomplished by using adhesion control additives in some interlayer materials, or by increasing the level of neutralization in an acid copolymer. Manipulating the neutralization level in an acid copolymer ionomer can cause other property changes, as well. Demands for increased adhesion, therefore, are not easily addressed in a conventional manner due to the expected decrease in impact toughness of the laminates upon increasing the acid content of the interlayer material and other changes that can result.

Further, it has become more desirable that the toughness of certain conventional polymeric interlayers be improved over that of current commercially available resins. As is easily recognized by one of ordinary skill in the art, modifying the intrinsic properties of a resin used in preparing interlayers for transparent laminates can affect other properties of the resin and interlayers produced therefrom. Recognizing this fact, changes to the acid level, the neutralization level, or other intrinsic characteristics is not straightforward.

Even more problematical, however, is the fact that commercially available acid copolymer resins need to be cooled quickly in order to provide laminates with desirable optical clarity that are useful as transparent laminate articles. The recommended cooling rate for laminates comprising conventional acid copolymer ionoplast resins is at least 5° F. per minute (2.78° C./min) or greater. In other words, by way of illustration, it is recommended that a laminate prepared using conventional conditions and a conventional ionoplast resin as interlayer material be cooled from an autoclave temperature of 275° F. (135° C.) to a temperature of 104° F. (40° C.) in less than about 35 minutes. However, in a practical sense this is not a trivial process condition because manufacturing processes are typically carried out under less than ideal conditions. This can be a problem because laminates comprising conventional ionoplast interlayers exhibit a tendency towards increased haze as the cooling rate is decreased. Differences in equipment and processing conditions can cause variation in product quality, even when carried out in the same facilities. The sensitivity of the optical clarity of an ionoplast interlayer to the cooling rate can be a problem in the manufacture of transparent laminates.

It can be desirable to have an improved resin composition for the purpose of increasing adhesion to rigid substrates, particularly adhesion to glass. It can be even more desirable to have such a resin provide a laminate with at least the same, or preferably improved impact resistance and toughness. Further, it can be desirable to prepare such a resin wherein an interlayer sheet produced from the resin has improved toughness relative to conventional interlayers. Moreover, it can be desirable to have all of these properties in a laminate that provides good optical clarity when designed for uses where optical clarity is a requirement.

### SUMMARY OF THE INVENTION

In one aspect, the present invention is an ionoplast resin composition comprising or consisting essentially of an ethylene acid copolymer and optionally, an effective amount of at least one additive, wherein (i) the ethylene acid copolymer comprises or consists essentially of residues derived from ethylene and from about 20 to about 30 wt % of residues derived from carboxylic acids selected from the group consisting of α,β-unsaturated acids having from 3 to 8 carbons, and from about 10% to about 90% of the carboxylic acid residues are neutralized; (ii) the ethylene acid copolymer has a melt index of about 60 g/10 min or less prior to neutralization; and (iii) the least one additive is selected from the group consisting of hindered amine light stabilizers (HALS), ultraviolet (UV) light absorbers, and thermal stabilizers.

In another aspect, the present invention is a shaped article comprising the resin composition of the present invention.

In a further aspect, the present invention is a multilayer film or sheet comprising at least one layer comprising the resin composition of the present invention.

In an even further aspect, the present invention is a transparent interlayer obtained from the resin composition of the invention.

In a still aspect, the present invention is a laminate article comprising at least one transparent interlayer of the invention.

In still another aspect, the present invention is a process for preparing a transparent laminate article having a haze of about 3% or less, comprising the steps of: (a) extruding at a temperature of from about 175° C. to about 250° C., an interlayer sheet of the invention; (b) fabricating a laminate from the interlayer by (1) setting up the interlayer and at least one other laminate layer to form a pre-laminate assembly and (2) heating the pre-laminate assembly to a temperature of at least about 120° C. and applying pressure or vacuum to the assembly for a period of time and (3) cooling the laminate to obtain the transparent laminate.

### DETAILED DESCRIPTION OF THE INVENTION

The following definitions apply to the terms as used throughout this specification, unless otherwise limited in specific instances.

The term “(meth)acrylic”, as used herein, alone or in combined form, such as “(meth)acrylate”, refers to acrylic and/or methacrylic, for example, acrylic acid and/or methacrylic acid, or alkyl acrylate and/or alkyl methacrylate.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The term “or”, when used alone herein, is inclusive; more specifically, the phrase “A or B” means “A, B, or both A and B”. Exclusive “or” is designated herein by terms such as “either A or B” and “one of A or B”, for example.

All percentages, parts, ratios, and the like set forth herein are by weight, unless otherwise limited in specific instances.

In addition, the ranges set forth herein include their endpoints unless expressly stated otherwise. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed.

In one embodiment, the present invention is an improved ionoplast resin composition, particularly suitable for use in the manufacture of transparent laminates. An ionoplast resin composition of the present invention comprises or consists essentially of an ethylene acid copolymer and optionally, an effective amount of at least one additive, wherein (i) the ethylene acid copolymer comprises or consists essentially of units derived from ethylene and from about 20 wt % to about 30 wt % of units derived from α,β-unsaturated carboxylic acids having from 3 to 8 carbons and (ii) the at least one additive is selected from the group consisting of hindered amine light stabilizers (HALS), ultraviolet (UV) light absorbers, and thermal stabilizers. Preferably, the ethylene acid copolymer comprises or consists essentially of units derived from ethylene and from about 20.5 to about 30 wt % of units derived from α,β-unsaturated carboxylic acids having from 3 to 8 carbons. More preferably, the ethylene acid copolymer comprises or consists essentially of units derived from ethylene and from about 21 to about 25 wt % of units derived from α,β-unsaturated carboxylic acids having from 3 to 8 carbons. Even more preferably, the ethylene acid copolymer comprises or consists essentially of units derived from ethylene and from about 21 to about 23 wt % of units derived from α,β-unsaturated carboxylic acids having from 3 to 8 carbons.

It should be understood for the purposes of the present application that control of the final acid level in a copolymer of the present invention is not exact, and therefore the range of acid in a final product can vary within about ±1 wt % of the disclosed ranges without departing from the intended scope of the present invention. Depending on the performance properties, manufacturing capabilities, or desirable process parameters, various acid levels can be preferred. For example, in some cases an acid level of about 20 wt % (that is 20±1 wt %) can be preferred, in other cases it can be preferred to have an acid level of about 20.5±1 wt %, about 21±1 wt %, or about 22±1 wt %.

Suitable carboxylic acid monomers whose residues may be comprised in the ethylene acid copolymer of the present invention includes, but not limited to, acrylic acid, methacrylic acid, itaconic acid, maleic acid, maleic anhydride, fumaric acid, monomethyl maleic acid, and mixtures thereof. The ethylene acid copolymers of the present invention may optionally further comprise residues of other unsaturated comonomers. Such unsaturated comonomers may be selected from the group consisting of methyl acrylate, methyl methacrylate, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, octyl acrylate, octyl methacrylate, undecyl acrylate, undecyl methacrylate, octadecyl acrylate, octadecyl methacrylate, dodecyl acrylate, dodecyl methacrylate, 2-ethylhexyl acrylate, 2-ethylhexyl methacrylate, isobornyl acrylate, isobornyl methacrylate, lauryl acrylate, lauryl methacrylate, 2-hydroxyethyl acrylate, 2-hydroxyethyl methacrylate, glycidyl acrylate, glycidyl methacrylate, poly(ethylene glycol)acrylate, poly(ethylene glycol)methacrylate, poly(ethylene glycol)methyl ether acrylate, poly(ethylene glycol)methyl ether methacrylate, poly(ethylene glycol)behenyl ether acrylate, poly(ethylene glycol)behenyl ether methacrylate, poly(ethylene glycol) 4-nonylphenyl ether acrylate, poly(ethylene glycol) 4-nonylphenyl ether methacrylate, poly(ethylene glycol)phenyl ether acrylate, poly(ethylene glycol)phenyl ether methacrylate, dimethyl maleate, diethyl maleate, dibutyl maleate, dimethyl fumarate, diethyl fumarate, dibutyl fumarate, dimenthyl fumarate, vinyl acetate, vinyl propionate, and mixtures thereof. Acrylic acid and methacrylic acid are preferred acid comonomers. The ethylene acid copolymers of the present invention may be polymerized as disclosed, for example, in U.S. Pat. Nos. 3,404,134; 5,028,674; 6,500,888 and 6,518,365.

The ethylene acid copolymers of the present invention are at least partially neutralized, and exist as partial salts comprising metal ions. The metal ions may be monovalent, divalent, trivalent, multivalent, or mixtures of ions having the same or different valencies. Exemplary monovalent metal ions include, but are not limited to, sodium, potassium, lithium, silver, mercury, copper, and mixtures thereof. Exemplary divalent metal ions include, but are not limited to, beryllium, magnesium, calcium, strontium, barium, copper, cadmium, mercury, tin, lead, iron, cobalt, nickel, zinc, and mixtures thereof. Exemplary trivalent metal ions include, but are not limited to, aluminum, scandium, iron, yttrium, and mixtures thereof. Exemplary multivalent metal ions include, but are not limited to, titanium, zirconium, hafnium, vanadium, tantalum, tungsten, chromium, cerium, iron, and mixtures thereof.

The ethylene acid copolymers of the present invention have from about 10% to about 90% of the carboxylic acid groups neutralized. Preferably, the ethylene acid copolymers of the present invention are from about 15% to about 45% neutralized, and more preferably from about 20% to about 35% neutralized. Even more preferably, the copolymers are from about 25% to about 35% neutralized. The ethylene acid copolymers of the present invention may be neutralized as disclosed, for example, in U.S. Pat. No. 3,404,134.

The ionoplast resin composition of the present invention, when used to prepare a laminate of the present invention, exhibits improved toughness relative to what would be expected of a laminate comprising a higher acid content in the interlayer as described herein. Without being held to theory, it is believed that improved toughness in the present invention is obtained by preparing an ethylene acid copolymer base resin with a lower melt index (MI) before it is neutralized. A base resin of the present invention preferably has a MI of less than 60 grams/10 min as determined at 190° C., and more preferably less than 55 grams/10 min. Still more preferably, the MI is less than 50 grams/10 min. Even more preferably the MI is less than 35 grams/10 min. After neutralization, the MI can be less than 2.5 grams/10 min, and possibly less than 1.5 g/10 min.

The compositions of the invention also include one or more additives selected from the group consisting of hindered amine light stabilizers (HALS), ultraviolet (UV) light absorbers, and thermal stabilizers. Any HALS known or presently unknown within the art may be utilized in the present invention. Generally, HALS are disclosed to be secondary, tertiary, acetylated, N-hydrocarbyloxy substituted, hydroxy substituted, N-hydrocarbyloxy substituted, or other substituted cyclic amines which further incorporate steric hindrance, generally derived from aliphatic substitution on the carbon atoms adjacent to the amine function. Exemplary HALS that may be comprised in the composition of the present invention include, but not limited to, 1,5,8,12-tetrakis[4,6-bis(N-butyl-N-1,2,2,6,6-pentamethyl-4-piperidylamino)-1,3,5-triazin-2-yl]-1,5,8,12-tetraazadodecane, bis(2,2,6,6-tetramethyl-4-piperidyl)sebacate, bis(1-octyloxy-2,2,6,6-tetramethyl-4-piperidyl)sebacate, poly[[6-[(1,1,3,3-tetramethylbutyl)amino]-s-triazine-2,4-diyl]-[(2,2,6,6-tetramethyl-4-piperidyl)imino]-hexamethylene-[(2,2,6,6-tetramethyl-4-piperidylimino]], poly[(6-morpholino-s-triazine-2,4-diyl)[2,2,6,6-tetramethyl-4-piperidyl)imino]-hexamethylene[(2,2,6,6-tetramethyl-4-piperidyl)imino]], bis-(2,2,6,6-tetramethylpiperidyl)sebacate, bis-(1,2,2,6,6-pentamethylpiperidyl)sebacate, condensation product of N,N′-(2,2,6,6-tetramethylpiperidyl)-hexamethylenediamine and 4-tert-octylamino-2,6-dichloro-s-triazine, tris(2,2,6,6-tetramethylpiperidyl)-nitrilotriacetate, tetrakis(2,2,6,6-tetramethyl-4-piperidyl)1,2,3,4-butanetetracarboxylate, 1,1′-(1,2-ethanediyl)-bis-(3,3,5,5-tetramethylpiperazinone), bis(1-octyloxy-2,2,6,6-tetramethylpiperidinyl)sebacate, 2-(2-hydroxyethylamino)-4,6-bis{N-[1-(cyclohexyloxy)-2,2,6,6-tetramethylpiperidin-4-yl]-butylamino-s-triazine, oligomer of N-{[2-(N-2,2,6,6-tetramethylpiperidin-4-yl)butylamino]-s-triazin-4-yl}-N,N′-bis(2,2,6,6-tetramethylpiperidin-4-yl)-1,6-hexanediamine terminated with 2,4-bis(dibutylamino)-s-triazin-6-yl, N,N′,N″-tris{2,4-bis[N-(1,2,2,6,6-pentamethylpiperidin-4-yl)butyl-amino]-s-triazin-6-yl}-3,3′-ethylenediiminodipropylamine, N,N′,N′″-tris{2,4-bis[N-(1,2,2,6,6-pentamethylpiperidin-4-yl)butylamino]-s-triazin-6-yl}-3,3′-ethylenediiminodipropylamine and N,N′,N″,N′″-tetrakis{2,4-bis[N-(1,2,2,6,6-pentamethylpiperidin-4-yl)butylamino]-s-triazin-6-yl}-3,3′-ethylenediiminodipropylamine; N,N′,N″-tris{2,4-bis[N-(1-cyclohexyloxy-2,2,6,6-tetramethyl-piperidin-4-yl)butylamino]-s-trazin-6-yl}-3,3′-ethylenediiminodipropylamine, N,N′,N′″-tris{2,4-bis[N-(1-cyclohexyloxy-2,2,6,6-tetramethylpiperidin-4-yl)butylamino]-s-triazin-6-yl}-3,3′-ethylenediiminodipropylamine, N,N′,N″,N′″-tetrakis{2,4-bis[N-(1-cyclohexyloxy-2,2,6,6-tetramethylpiperidin-4-yl)butylamino]-s-triazin-6-yl}-3,3′-ethylenediiminodipropylamine, bis(1,2,2,6,6-pentamethylpiperidin-4-yl)(3,5-di-tert-butyl-4-hydroxybenzyl)butylmalonate, 4-benzoyl-2,2,6,6-tetramethylpiperidine, 4-stearyloxy-2,2,6,6-tetramethylpiperidine, 3-n-octyl-7,7,9,9-tetramethyl-1,3,8-triaza-spiro[4.5]decane-2,4-dione, 1,2-bis(2,2,6,6-tetramethyl-3-oxopiperazin-4-yl)ethane, 2,2,4,4-tetramethyl-7-oxa-3,20-diaza-21-oxodispiro[5.1.11.2]heneicosane, polycondensation product of 2,4-dichloro-6-tert-octylamino-s-triazine and 4,4′-hexamethylenebis(amino-2,2,6,6-tetramethylpiperidine), polycondensation product of 1-(2-hydroxyethyl)-2,2,6,6-tetramethyl-4-hydroxypiperidine and succinic acid, polycondensation product of 4,4′-hexamethylenebis-(amino-2,2,6,6-tetra-methylpiperidine) and 1,2-dibromoethane, tetrakis(2,2,6,6-tetramethylpiperidin-4-yl)1,2,3,4-butanetetracarboxylate, tetrakis(1,2,2,6,6-pentamethylpiperidin-4-yl)1,2,3,4-butanetetracarboxylate, polycondensaton product of 2,4-dichloro-6-morpholino-s-triazine and 4,4′-hexamethylenebis(amino-2,2,6,6-tetramethylpiperidine), N,N′,N″,N′″-tetrakis[(4,6-bis(butyl-1,2,2,6,6-pentamethylpiperidin-4-yl)-amino-s-triazin-2-yl]-1,10-diamino-4,7-diazadecane, polycondensation product of 2,4-dichloro-6-morpholino-s-triazine and 4,4′-hexamethylenebis(amino-1,2,2,6,6-pentamethylpiperidine), mixed [2,2,6,6-tetramethylpiperidin-4-yl-beta,beta,beta′,beta′-tetramethyl-3,9-(2,4,8,10-tetraoxaspiro[5.5]-undecane)diethyl]1,2,3,4-butanetetracarboxylate, mixed [1,2,2,6,6-pentamethylpiperidin-4-yl-beta,beta,beta′,beta′-tetramethyl-3,9-(2,4,8,10-tetraoxaspiro[5.5]undecane)diethyl]1,2,3,4-butanetetracarboxylate, octamethylene bis(2,2,6,6-tetramethylpiperidin-4-carboxylate), 4,4′-ethylenebis(2,2,6,6-tetramethylpiperazin-3-one), N-2,2,6,6-tetramethylpiperidin-4-yl-n-dodecylsuccinimide, N-1,2,2,6,6-pentamethylpiperidin-4-yl-n-dodecylsuccinimide, N-1-acetyl-2,2,6,6-tetramethylpiperidin-4-yl-n-dodecylsuccinimide, 1-acetyl3-dodecyl-7,7,9,9-tetramethyl-1,3,8-triazaspiro[4.5]decane-2,4-dione, bis(1-cyclohexyloxy-2,2,6,6-tetramethylpiperidin-4-yl)succinate, 1-octyloxy-2,2,6,6-tetramethyl-4-hydroxy-piperidine, poly{[6-tert-octylamino-s-triazin-2,4-diyl][2-(1-cyclohexyloxy-2,2,6,6-tetramethylpiperidin-4-yl)imino-hexamethylene-[4-(1-cyclohexyloxy-2,2,6,6-tetramethylpiperidin-4-yl)imino], 2,4,6-tris[N-(1-cyclohexyloxy-2,2,6,6-tetramethylpiperidin-4-yl)-n-butylamino]-s-triazine, 2-(2-hydroxyethylamino)4,6-bis{N-[1-(cyclohexyloxy)-2,2,6,6-tetramethylpiperidin-4-yl]-butylamino-s-triazine, oligomer of N-{2-[(1-propoxy-2,2,6,6tetramethylpiperidin-4-yl)butylamino]-s-triazin-4-yl}-N,N′-bis(1-propoxy-2,2,6,6-tetramethylpiperidin-4-yl)-1,6-hexanediamine terminated with 2,4-bis(dibutylamino)-s-triazin-6-yl, 2,2,6,6-tetramethylpiperidin-4-yl octadecanoate, 3-dodecyl-1-(1-acetyl-2,2,6,6-tetramethylpiperidin-4-yl)-pyrrolidin-2,5-dione, 1,3,5-tris{N-cyclohexyl-N-[2-(2,2,6,6-tetramethylpiperazin-3-on-4-yl)ethyl]amino}-s-triazine, poly[methyl 3-(2,2,6,6-tetramethylpiperidin-4-yloxy)propyl]siloxane, bis(1-octyloxy-2,2,6,6-tetramethylpiperidin-4-yl)adipate, bis(1-cyclohexyloxy-2,2,6,6-tetramethylpiperidin-4-yl)adipate, bis(1-cyclohexyloxy-2,2,6,6-tetramethylpiperidin-4-yl)sebacate, 1-cyclohexyloxy-2,2,6,6-tetramethylpiperidin-4-yl octadecanoate, bis[1-(2-hydroxy-2-methylpropoxy)-2,2,6,6-tetramethylpiperidin-4-yl)]sebacate, a mixture of bis[1-(2-hydroxy-2-methylpropoxy)-2,2,6,6-tetramethylpiperidin-4-yl]glutarate and bis[1-(2-hydroxy-2-methylpropoxy)-2,2,6,6-tetramethylpiperidin-4-yl]adipate, 1-(2-hydroxy-2-methylpropoxy)-4-octadecanoyloxy-2,2,6,6-tetramethylpiperidine, bis[1-(2-hydroxy-2-methylpropoxy)-2,2,6,6-tetramethylpiperidin-4-yl]adipate, bis[1-(2-hydroxy-2-methylpropoxy)-2,2,6,6-tetramethylpiperidin-4-yl]glutarate, bis[1-(2-hydroxy-2-methylpropoxy)-2,2,6,6-tetramethylpiperidin-4-yl]succinate, a mixture of bis[1-(2-hydroxy-2-methylpropoxy)-2,2,6,6-tetramethylpiperidin-4-yl]glutarate and bis[1-(2-hydroxy-2-methylpropoxy)-2,2,6,6-tetramethylpiperidin-4-yl]succinate, 1-(4-octadecanoyloxy-2,2,6,6-tetramethylpiperidin-1-yloxy)-2-octadecanoyloxy-2-methylpropane, 1-(2-hydroxy-2-methylpropoxy)-4-[9-(methoxy-carbonyl)nonanoyloxy]-2,2,6,6-tetramethylpiperidine, 1-(2-hydroxy-2-methylpropoxy)-4-[5-(methoxy-carbonyl)pentanoyloxy]-2,2,6,6-tetramethylpiperidine, 1-(2-hydroxy-2-methylpropoxy)-4-[3-(methoxy-carbonyl)propionyloxy]-2,2,6,6-tetramethylpiperidine, 1-(2-hydroxy-2-methylpropoxy)-4-[4-(methoxy-carbonyl)butyryloxy]-2,2,6,6-tetramethylpiperidine, bis(2,2,6,6-tetramethyl-4-piperidyl)succinate, bis(1,2,2,6,6-pentamethylpiperidyl)-2-n-butyl-2-(2-hydroxy-3,5-di-tert-butylbenzyl)-malonate, bis(1-octyloxy-2,2,6,6-tetramethylpiperidyl)succinate, the condensate of 2-chloro-4,6-bis(4-n-butylamino-2,2,6,6-tetramethylpiperidyl)-1,3,5-triazine and 1,2-bis(3-aminopropylamino)-ethane, the condensate of 2-chloro-4,6-di-(4-n-butylamino-1,2,2,6,6-pentamethylpiperidyl)-1,3,5-triazine and 1,2-bis(3-aminopropylamino)ethane, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]), a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]), 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, a reaction product of maleic acid anhydride-.alpha.-olefin copolymer with 2,2,6,6-tetramethyl-4-aminopiperidine or 1,2,2,6,6-pentamethyl-4-aminopiperidine, 1,2-bis(3,3,5,5-tetramethylpiperazin-2-on-1-yl)ethane, 1,3,5-tris{N-cyclohexyl-N-[2-(3,3,5,5-tetramethylpiperazin-2-on-1-yl)ethyl]amino}-s-triazine, 1,3,5-tris{N-cyclohexyl-N-[2-(3,3,4,5,5-pentaamethylpiperazin-2-on-1-yl)ethyl]amino}-s-triazine, reaction of 2-4 equivalents of 2,4-bis[(1-cyclohexyloxy-2,2,6,6-tetramethylpiperidin-4-yl)butyl-amino]-6- chloro-s-triazine with 1 equivalent of N,N′-bis(3-aminopropyl)ethylenediamine, 4-hydroxy-1-(2-hydroxy-2-methylpropoxy)-2,2,6,6-tetramethylpiperidine and 4-octadecyloxy-1-(2-hydroxy-2-methylpropoxy)-2,2,6,6-tetramethylpiperidine, and mixtures thereof. The compositions of the present invention may comprise from about 0.01 to about 10.0 wt % of the HALS and preferably, from about 0.01 to about 5.0 wt %. More preferably, the compositions of the present invention comprise from about 0.01 to about 1.0 wt % of the HALS. Most preferably, the compositions of the present invention comprise from about 0.01 to about 0.5 wt % of the HALS.

Any UV light absorbers known or yet to be known within the art may find utility in the present invention. The general classes of UV absorbers including benzotriazoles, hydroxybenzophenones, hydroxyphenyl triazines, esters of substituted and unsubstituted benzoic acids, are within the definition of UV light stabilizers of the present invention. Exemplary UV absorbers that may be contained in the present compositions include, but not limited to, 2,4-dihydroxybenzophenone, 2-hydroxy-4-methoxybenzophenone, 2-hydroxy-4-decyloxybenzophenone, 2-hydroxy-4-dodecyloxybenzophenone, 2-hydroxy-4-benzyloxybenzophenone, 2,2′,4,4′-tetrahydroxybenzophenone, 2,2′-dihydroxy-4,4′-dimethoxybenzophenone, 2-hydroxy-4-n-octyloxybenzophenone, 4-methoxy-2,2′-dihydroxybenzophenone, 2-(2-hydroxy-5-tert-octylphenyl)benzotriazole, 2-(2H-benzotriazol-2-yl)-4,6-di-tert-pentylphenol, 2,2′-methylenebis[6-(2H-benzotriazol-2-yl)-4-(1,1,3,3-tetramethylbutyl)phenol], 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyl-oxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-5′-[2-(2-ethylhexyloxy)carbonylethyl]-2′-hydroxy-phenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, the transesterification product of 2-[3′-tert-butyl-5′-(2-methoxycarbonylethyl)-2′-hydroxyphenyl]-2H-benzotriazole with polyethylene glycol, 2-[2′-hydroxy-3′-(1,3,3-dimethylbenzyl)-5′-(1,1,3,3-tetramethylbutyl)phenyl]-benzotriazole, 2-[2′-hydroxy-3′-(1,1,3,3-tetramethylbutyl)-5′-(alpha,alpha-dimethylbenzyl)phenyl]benzotriazole, 5-chloro-2-(2-hydroxy-3,5-di-tert-butylphenyl)-2H-benzotriazole, 2-(2-hydroxy-3,5-di-alpha-cumylphenyl)-2H-benzotriazole, 2-(2-hydroxy-3-alpha-cumyl-5-tert-octylphenyl)-2H-benzotriazole, 2-[2-hydroxy-3-(alpha,alpha-dimethylbenzyl)-5-tert-octylphenyl]-2H-benzotriazole, 5-chloro-3′,5′-di-tert-butyl-, 2-(2′-hydroxyphenyl)-benzotriazole, 5-chloro-3′-tert-butyl-5′-methyl-2-(2′-hydroxyphenyl)benzotriazole, 3′-sec-butyl-5′-tert-butyl-2-(2′-hydroxyphenyl)benzotriazole, 3′-tert-butyl-5′-(2-(omega-hydroxy-octa-(ethyleneoxy)carbonyl-ethyl-2-(2′-hydroxyphenyl)benzotriazole, 3′-tert-butyl-5′-(2-octyloxycarbonyl)ethyl-2-(2′-hydroxyphenyl)benzotriazole, dodecylated-5′-methyl2-(2′-hydroxyphenyl)benzotriazole, 2-(2H-benzotriazol-2-yl)-4,6-bis(1-methyl-1-phenylethyl)phenol, 2-(2H-benzotriazol-2-yl)-4-(1,1,3,3-tetramethylbutyl)phenol, 2-{2-hydroxy-3-tert-butyl-5-[2-(omega-hydroxy-octa(ethyleneoxy)carbonyl)ethyl]phenyl}-2H-benzotriazole, 2-{2-hydroxy-3-tert-butyl-5-[2-(octyloxy)carbonyl)ethyl]phenyl}-2H-benzotriazole, 5-trifluoromethyl-2-(2-hydroxy-3-.alpha.-cumyl-5-tert-octylphenyl)-2H-benzotrdazole, 5-trifluoromethyl-2-(2-hydroxy-5-tert-octylphenyl)-2H-benzotriazole, 5-trifluoromethyl-2-(2-hydroxy-3,5-di-tert-octylphenyl)-2H-benzotriazole, 2,2′-methylene-bis[6-(5-trifluoromethyl-2H-benzotriazol-2-yl)-4-tert-octyl phenol], methylene-2-[4-tert-octyl-6-(2H-benzotriazol]-2-yl)phenol]-2′-[4-tert-octyl-6-(5-trifluoromethyl-2H-benzotriazol-2-yl)phenol], 3-(5-trifluoromethyl-2H-benzotriazol-2-yl)-5-tert-butyl-4-hydroxyhydrocinnamic acid, methyl 3-(5-trifluoromethyl-2H-benzotriazol-2-yl)-5-tert-butyl-4-hydroxyhydrocinnamate, isooctyl 3-(5-trifluoromethyl-2H-benzotriazol-2-yl)-5-tert-butyl-4-hydroxyhydrocinnamate, 5-trifluoromethyl-2-[2-hydroxy-5-(3-hydroxypropyl)phenyl]-2H-benzotriazole, 5-trifluoromethyl-2-[2-hydroxy-5-(3-acryloyloxypropyl)phenyl]-2H-benzotriazole, 5-trifluoromethyl-2-[2-hydroxy-5-(3-methacryloyloxypropyl)phenyl]-2H-benzotriazole, 5-trifluoromethyl-2-[2-hydroxy-5-(3-acrylylaminopropyl)phenyl]-2H-benzotriazole, 5-trifluoromethyl-2-[2-hydroxy-5-(3-methacrylylaminopropyl)phenyl]-2H-benzotriazole, 5-trifluoromethyl-2-(2-hydroxy-3-.alpha.-cumyl-5-tert-butylphenyl)-2H-benzotriazole, 5-trifluoromethyl-2-(2-hydroxy-3-.alpha.-cumyl-5-nonylphenyl)-2H-benzotriazole, 5-trifluoromethyl-2-[2-hydroxy-3-.alpha.-cumyl-5-(2-hydroxyethyl)phenyl]-2H-benzotriazole, 5-trifluoromethyl-2-[2-hydroxy-3-.alpha.-cumyl-5-(3-hydroxypropyl)phenyl]-2H-benzotriazole, 5-trifluoromethyl-2-(2-hydroxy-3,5-di-tert-amylphenyl)-2H-benzotriazole, 5-trifluoromethyl-2-(2-hydroxy-3,5-di-tert-butylphenyl)-2H-benzotriazole, 5-trifluoromethyl-2-(2-hydroxy-3-dodecyl-5-methylphenyl)-2H-benzotriazole, 5-trifluoromethyl-2-[2-hydroxy-3-tert-butyl-5-(3-hydroxypropyl)phenyl)-2H-benzotriazole, 5-trifluoromethyl-2-[2-hydroxy-3-tert-butyl-5-(2-hydroxyethyl)phenyl]-2H-benzotriazole, 5-trifluoromethyl-2-[2-hydroxy-5-(2-hydroxyethyl)phenyl]-2H-benzotriazole, 5-trifluoromethyl-2-(2-hydroxy-3,5-di-.alpha.-cumylphenyl)-2H-benzotriazole, 5-fluoro-2-(2-hydroxy-3, 5-di-.alpha.-cumylphenyl)-2H-benzotriazole, 5-butylsulfonyl-2-(2-hydroxy-3,5-di-.alpha.-cumylphenyl)-2H-benzotriazole, 5-butylsulfonyl-2-(2-hydroxy-3,5-di-tert-butylphenyl)-2H-benzotriazole, 5-butylsulfonyl-2-(2-hydroxy-3,5-di-tert-octylphenyl)-2H-benzotdazole, 5-phenylsulfonyl-2-(2-hydroxy-3,5-di-tert-butylphenyl)-2H-benzotriazole, 2-(4,6-diphenyl-1,3,5-triazin-2-yl)-5-[(hexyl)oxy]-phenol, 2,4-bis(4-biphenylyl)-6-(2-hydroxy-4-octyloxycarbonylethylideneoxyphenyl)-s-triazine, 2-phenyl-4-[2-hydroxy-4-(3-sec-butyloxy-2-hydroxypropyloxy)phenyl]-6-[2-hydroxy-4-(3-sec-amyloxy-2-hydroxypropyloxy)phenyl]-s-triazine, 2,4-bis(2,4-dimethylphenyl)-6-[2-hydroxy-4-(3-benzyloxy-2-hydroxypropyloxy)phenyl]-2-triazine, 2,4-bis(2-hydroxy-4-butyloxyphenyl)-6-(2,4-di-butyloxyphenyl)-s-triazine, 2,4-bis(2,4-dimethylphenyl)-6-[2-hydroxy-4-(3-nonyloxy*-2-hydroxypropyloxy)-5-alpha-cumyl-phenyl]-s-triazine), (*denotes a mixture of octyloxy, nonyloxy and decyloxy groups), methylenebis-{2,4-bis(2,4-dimethylphenyl)-6-[2-hydroxy-4-(3-butyloxy-2-hydroxypropoxy)-phenyl]-s-triazine}, methylene bridged dimer mixture bridged in the 3:5′, 5:5′ and 3:3′ positions in a 5:4:1 ratio, 2,4,6-tris(2-hydroxy-4-isooctyloxycarbonylisopropylideneoxyphenyl)-s-triazine, 2,4-bis(2,4-dimethylphenyl)-6-(2-hydroxy-4-hexyloxy-5-alpha-cumylphenyl)-s-triazine, 2,4-bis(2,4-dimethylphenyl)-6-(2-hydroxy-4-octyloxyphenyl)-s-triazine, 2-(2,4,6-trimethylphenyl)-4,6-bis[2-hydroxy-4-(3-butyloxy-2-hydroxypropyloxy)phenyl]-s-triazine, 2,4,6-tris[2-hydroxy-4-(3-sec-butyloxy-2-hydroxypropyloxy)phenyl]-s-triazine, 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyhenyl]-4,6-bis(2,4-dimethylphenyl)-1,3,5-triazine, 2-[2-hydroxy-4-(2-hydroxy-3-dodecyloxypropoxy)phenyl]4,6-bis(2,4-dimethyl phenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, 2,4-bis(2,4-dimethylphenyl)-6-[2-hydroxy-4-(3-nonyloxy-2-hydroxypropyloxy)-5-alpha-cumylphenyl]-s-triazine, 2,4-bis(4-biphenylyl)-6-(2-hydroxy-4-octyloxycarbonylethylideneoxyphenyl)-s-triazine, 2-phenyl-4-[2-hydroxy-4-(3-sec-butyloxy-2-hydroxypropyloxy)phenyl]-6-[2-hydroxy-4-(3-sec-amyloxy-2-hydroxypropyloxy)phenyl]-s-triazine, 2,4-bis(2,4-dimethylphenyl)-6-[2-hydroxy-4-(3-benzyloxy-2-hydroxypropyloxy)phenyl]-s-triazine, 2,4-bis(2-hydroxy-4-n-butyloxyphenyl)-6-(2,4-di-n-butyloxyphenyl)-s-triazine, 2,6-bis-(2,4-dimethylphenyl)-4-(2,4-dihydroxyphenyl)-s-triazine, 2,4-bis(2,4-dihydroxyphenyl)-6-(4-chlorophenyl)-s-triazine, 2,4-bis[2-hydroxy-4-(2-hydroxyethoxy)phenyl]-6-(4-chlorophenyl)-s-triazine, 2,4-bis[2-hydroxy-4-(2-hydroxy-4-(2-hydroxyethoxy)phenyl]-6-(2,4-dimethylphenyl)-s-triazine, 2,4-bis[2-hydroxy-4-(2-hydroxyethoxy)-phenyl]-6-(4-bromophenyl)-s-triazine, 2,4-bis[2-hydroxy-4-(2-acetoxyethoxy)phenyl]-6-(4-chlorophenyl)-s-triazine, 2,4-bis(2,4-dihydroxyphenyl)-6-(2,4-dimethylphenyl)-s-triazine, 2,4-bis(2,4-dimethylphenyl)-6-(2-hydroxy-4-octyloxyphenyl)-s-triazine, 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate, and mixtures thereof. The compositions of the present invention may contain from about 0.01 to about 10.0 wt % of UV light absorbers, or preferably, from about 0.01 to about 5.0 wt %. More preferably, the compositions of the present invention contain from about 0.01 to about 1.0 wt % of UV light absorbers. Most preferably, the compositions of the present invention contain from about 0.01 to about 0.5 wt % of UV light absorbers.

An effective amount of thermal stabilizers may also be contained in the present composition. In general, any known or yet to be known thermal stabilizers may find utility in the present composition. Commonly known classes of thermal stabilizers include phenolic antioxidants, alkylated monophenols, alkylthiomethylphenols, hydroquinones, alkylated hydroquinones, tocopherols, hydroxylated thiodiphenyl ethers, alkylidenebisphenols, O—, N— and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds which destroy peroxide, hydroxylamines, nitrones, thiosynergists, benzofuranones, and indolinones. Exemplary thermal stabilizers of the present invention include, but not limited to, 2,6-di-tert-butyl-4-methylphenol, 2,6-di-tert-butyl-p-cresol, 2-tert-butyl-4,6-dimethylphenol, 2,6-di-tert-butyl-4-ethylphenol, 2,6-di-tert-butyl-4-n-butylphenol, 2,6-di-tert-butyl-4-i-butylphenol, 2,6-di-cyclopentyl-4-methylphenol, 2-(alpha-methylcyclohexyl)-4,6-dimethylphenol, 2,6-dioctadecyl-4-methylphenol, 2,4,6-tricyclohexylphenol, 2,6-di-tert-butyl-4-methoxymethylphenol, 2,6-di-tert-butyl-4-methoxyphenol, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol, 2,5-di-tert-butyl-hydroquinone, 2,5-di-tert-amyl-hydroquinone, 2,6-diphenyl-4-octadecyloxyphenol, 2,2′-bis-(6-tert-butyl-4-methylphenol), 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate, 2,2′-thio-bis(4-octylphenol), 4,4′-thio-bis(6-tert-butyl-3-methylphenol), 4,4′-thio-bis(6-tert-butyl-2-methylphenol), 2,2′-methylenebis-(6-tert-butyl-4-methylphenol), 2,2′-methylene-bis(6-tert-butyl-4-ethylphenol), 2,2′-methylene-bis[4-methyl-6-(alpha-methylcyclohexyl)phenol], 2,2′-methylene-bis(4-methyl-6-cyclohexylphenol), 2,2′-methylene-bis(6-nonyl-4-methylphenol), 2,2′-methylene-bis[6-(alpha-methylbenzyl)-4-nonylphenol], 2,2′-methylene-bis[6-(alpha,alpha-dimethylbenzyl)-4-nonylphenol], 2,2′-methylene-bis(4,6-di-tert-butylphenol), 2,2′-ethylidene-bis(4,6-di-tert-butylphenol), 2,2′-ethylidene-bis(6-tert-butyl-4-isobutylphenol), 4,4′-methylene-bis(2,6-di-tert-butylphenol), 4,4′-methylene-bis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)-butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate], ethylene bis[3,3-di(3-tert-butyl-4-hydroxyphenyl)butyrate], bis(3-tert-butyl-4-hydroxy-5-methylphenyl)-dicyclopentadiene, bis[2-(3′-tert-butyl-2′-hydroxy-5′-methyl-benzyl)-6-tert-butyl-4-methylphenyl]terephthalate, 2,2′-methylenebis(6-tert-butyl-4-ethylphenol), 1,1-bis(3,5-dimethyl-2-hydroxyphenyl)butane, 2,2-bis(3,5-di-tert-butyl-4-hydroxyphenyl)propane, 2,2-bis(5-tert-butyl-4-hydroxy2-methylphenyl)-4-n-dodecylmercaptobutane, 1,1,5,5-tetra(5-tert-butyl-4-hydroxy-2-methylphenyl)pentane, 1,3,5-tri(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol, bis(3,5-di-tert-butyl-4-hydroxybenzyl)sulfide, 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)-disulfide, 3,5-di-tert-butyl-4-hydroxybenzyl-mercapto-acetic acid isooctyl ester, isooctyl-3,5-di-tert-butyl-4-hydroxybenzylmercaptoacetate, octyl 3,5-di-tert-butyl-4-hydroxybenzylmercaptoacetate, 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, 2,4-dioctylthiomethyl-6-tert-butylphenol, 2,4-dioctylthiomethyl-6-methylphenol, 2,4-dioctylthiomethyl-6-ethylphenol, 2,6-di-dodecylthiomethyl-4-nonylphenol, dioctadecyl-2,2-bis(3,5-di-tert-butyl-2-hydroxybenzyl)malonate, di-octadecyl-2-(3-tert-butyl-4-hydroxy-5-methylbenzyl)malonate, didodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate, 1,3,5-tris(3,5-di-tert-butyl-4-hydroxybenzyl)isocyanurate, 1,3,5-tris[2-(3,5-di-tert-butyl-4-hydroxyhydrocinnamoyloxy)ethyl]isocyanurate, 1,3,5-tris(4-tert-butyl-3-hydroxy-2,6-dimethylbenzyl)isocyanurate, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate, 3,5-di-tert-butyl-4-hydroxybenzyl-phosphoric acid dioctadecyl ester, di(n-octadecyl)-3,5-di-tert-butyl-4-hydroxybenzylphosphonate, dimethyl-2,5-di-tert-butyl-4-hydroxybenzylphosphonate, diethyl-3,5-di-tert-butyl-4-hydroxybenzylphosphonate, dioctadecyl-5-tert-butyl-4-hydroxy-3-methylbenzylphosphonate, calcium bis(ethyl3,5-di-tert-butyl-4-hydroxybenzyl-phosphonate), 3,5-di-tert-butyl-4-hydroxybenzyl-phosphoric acid monoethyl ester, calcium-salt, 3,5-di-(3,5-di-tert-butyl-4-hydroxybenzyl)mesitol, 4-hydroxylauranilide, 4-hydroxystearanilide, 2,4-bis(octylmercapto)-6-(3,5-tert-butyl-4-hydroxyanilino)-s-triazine, 1-(3,5-di-tert-butyl-4-hydroxyanilino)-3,5-di(octylthio)-s-triazine, octyl-N-(3,5-di-tert-butyl-4-hydroxyphenyl)-carbamate, methyl beta-(3,5-di-tert-butyl-4-hydroxyphenyl)propioniate, octadecyl beta-(3,5-di-tert-butyl-4-hydroxyphenyl)propioniate, n-octadecyl 3,5-di-tert-butyl-4-hydroxyhydrocinnamate, 1,6-hexyl bis[beta-(3,5-di-tert-butyl-4-hydroxyphenyl)propioniate], hexamethylene bis(3,5-di-tert-butyl-4-hydroxyhydrocinnamate), neopentyl bis[beta-(3,5-di-tert-butyl-4-hydroxyphenyl)propioniate], thiodiethylene bis[beta-(3,5-di-tert-butyl-4-hydroxyphenyl)propioniate], thiodiethylene bis(3,5-di-tert-butyl-4-hydroxyhydrocinnamate), triethanol amine tris[beta-(3,5-di-tert-butyl-4-hydroxyphenyl)propioniate], diethylene bis[beta-(3,5-di-tert-butyl-4-hydroxyphenyl)propioniate], triethylene bis[beta-(3,5-di-tert-butyl-4-hydroxyphenyl)propioniate], pentaerythritol tetrakis[beta-(3,5-di-tert-butyl-4-hydroxyphenyl)propioniate], neopentanetetrayl tetrakis(3,5-di-tert-butyl-4-hydroxyhydrocinammate), tris(hydroxyethyl)isocyanurate tris[beta-(3,5-di-tert-butyl-4-hydroxyphenyl)propioniate], dihydroxyethyl oxalic acid diamide bis[beta-(3,5-di-tert-butyl-4-hydroxyphenyl)propioniate], trispropanol amine tris[beta-(3,5-di-tert-butyl-4-hydroxyphenyl)propioniate], methyl (3,5-di-tert-butyl-4-hydroxyphenyl)acetate, octadecyl (3,5-di-tert-butyl-4-hydroxyphenyl)acetate, 1,6-hexyl bis[(3,5-di-tert-butyl-4-hydroxyphenyl)acetate], neopentyl bis[(3,5-di-tert-butyl-4-hydroxyphenyl)acetate], thiodiethylene bis[(3,5-di-tert-butyl-4-hydroxyphenyl)acetate], triethanol amine tris[(3,5-di-tert-butyl-4-hydroxyphenyl)acetate], diethylene bis[(3,5-di-tert-butyl-4-hydroxyphenyl)acetate], triethylene bis[(3,5-di-tert-butyl-4-hydroxyphenyl)acetate], pentaerythritol tetrakis[(3,5-di-tert-butyl-4-hydroxyphenyl)acetate], tris(hydroxyethyl)isocyanurate tris[(3,5-di-tert-butyl-4-hydroxyphenyl)acetate], dihydroxyethyl oxalic acid diamide bis[(3,5-di-tert-butyl-4-hydroxyphenyl)acetate], trispropanol amine tris[(3,5-di-tert-butyl-4-hydroxyphenyl)acetate], methyl beta-(5-tert-butyl-4-hydroxy-3-methylphenyl)propioniate, octadecyl beta-(5-tert-butyl-4-hydroxy-3-methylphenyl)propioniate, 1,6-hexyl bis[beta-(5-tert-butyl-4-hydroxy-3-methylphenyl)propioniate], neopentyl bis[beta-(5-tert-butyl-4-hydroxy-3-methylphenyl)propioniate], thiodiethylene bis[beta-(5-tert-butyl-4-hydroxy-3-methylphenyl)propioniate], tirethanol amine tris[beta-(5-tert-butyl-4-hydroxy-3-methylphenyl)propioniate], diethylene bis[beta-(5-tert-butyl-4-hydroxy-3-methylphenyl)propioniate], triethylene bis[beta-(5-tert-butyl-4-hydroxy-3-methylphenyl)propioniate], pentaerythritol tetrakis[beta-(5-tert-butyl-4-hydroxy-3-methylphenyl)propioniate], tris(hydroxyethyl)isocyanurate tris[beta-(5-tert-butyl-4-hydroxy-3-methylphenyl)propioniate], dihydroxyethyl oxalic acid diamide bis[beta-(5-tert-butyl-4-hydroxy-3-methylphenyl)propioniate], methyl beta-(3,5-dicyclohexal-4-hydroxyphenyl)propioniate, octadecyl beta-(3,5-dicyclohexal-4-hydroxyphenyl)propioniate, 1,6-hexyl bis[beta-(3,5-dicyclohexal-4-hydroxyphenyl)propioniate], hexamethylene bis(3,5-dicyclohexal-4-hydroxyhydrocinnamate), neopentyl bis[beta-(3,5-dicyclohexal-4-hydroxyphenyl)propioniate], thiodiethylene bis[beta-(3,5-dicyclohexal-4-hydroxyphenyl)propioniate], triethanol amine tris[beta-(3,5-dicyclohexal-4-hydroxyphenyl)propioniate], diethylene bis[beta-(3,5-dicyclohexal-4-hydroxyphenyl)propioniate], triethylene bis[beta-(3,5-dicyclohexal-4-hydroxyphenyl)propioniate], pentaerythritol tetrakis[beta-(3,5-dicyclohexal-4-hydroxyphenyl)propioniate], neopentanetetrayl tetrakis(3,5-dicyclohexal-4-hydroxyhydrocinammate), tris(hydroxyethyl)isocyanurate tris[beta-(3,5-dicyclohexal-4-hydroxyphenyl)propioniate], dihydroxyethyl oxalic acid diamide bis[beta-(3,5-dicyclohexal-4-hydroxyphenyl)propioniate], trispropanol amine tris[beta-(3,5-dicyclohexal-4-hydroxyphenyl)propioniate], N,N′-hexamethylene-bis(3,5-di-tert-butyl-4-hydroxyhydrocinnamamide), bis(3,5-di-tert-butyl-4-hydroxyhydrocinnamoyl)hydrazide, N,N′-bis(3,5-di-tert-butyl-4-hydroxyphenylpropionyl)hexamethylenediamide, N,N′-bis(3,5-di-tert-butyl-4-hydroxyphenylpropionyl)trimethylenediamide, N,N′-bis(3,5-di-tert-butyl-4-hydroxyphenylpropionyl)hydrazine, N,N′-bis[2-(3-[3, 5-di-tert-butyl-4-hydroxyphenyl]propionyloxy)ethyl]oxamide, 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides, ascorbic acid (vitamin C), tocopherols, for example alpha-tocopherol, beta-tocopherol, gamma-tocopherol, delta-tocopherol and mixtures thereof (vitamin E), diphenylamine, N-phenyl-1-naphthylamine, N-(4-tert-octylphenyl)-1-naphthylamine, 4,4′-di-tert-octyl-diphenylamine, reaction product of N-phenylbenzylamine and 2,4,4-trimethylpentene, reaction product of diphenylamine and 2,4,4-trimethylpentene, reaction product of N-phenyl-1-naphthylamine and 2,4,4-trimethylpentene, N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenyl-amine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butyl-aminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyidiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octylphenothiazines, N-allylphenothiazine, N,N,N′,N′-tetraphenyl-1,4-diaminobut-2-ene, N,N-bis(2,2,6,6-tetra-methylpiperid-4-yl-hexamethylenediamine, bis(2,2,6,6-tetramethylpiperid-4-yl)sebacate, 2,2,6,6-tetramethylpiperidin-4-one, 2,2,6,6-tetramethylpiperidin-4-ol, N-salicylal-N′-salicyloylhydrazine, N,N′-bis-salicyloylhydrazine, N,N′-bis-(3,5-di-tert-butyl-4-hydroxyphenylpropionyl)hydrazine, 3-salicyloylamino-1,2,4-triazole, N,N′-diphenyloxamide, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyloyl)oxalyl dihydrazide, N,N′-bis(salicyloyl)thiopropionyl dihydrazide, triphenyl phosphite, diphenylalkyl phosphites, phenyldialkyl phosphites, tri(nonylphenyl)phosphite, trilaurylphosphite, trioctadecylphosphite, distearylpentaerythritol diphosphite, tris(2,4-di-tert-butylphenyl)phosphite, di-isodecylpentaerythritol diphosphite, bis(2,4,6-tri-tert-butylphenyl)pentaerythritol diphosphite, bis(2,4-di-tert-butyl-6-methylphenyl)-pentaerythritol diphosphite, bis(2,4-di-tert-butylphenyl)pentaerythritol diphosphite, bis(2,4-di-tert-butyl-6-methylphenyl)ethyl phosphite, 2,2′-ethylidenebis(2,4-di-tert-butylphenyl)fluorophosphite, 2-butyl-2-ethylpropan-1,3-diyl 2,4,6-tri-tert-butylphenyl phosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo-[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, esters of .beta.-thiodipropionic acid, for example the lauryl, stearyl, myristyl or tridecyl esters, mercapto-benzimidazole or the zinc salt of 2-mercaptobenzimidazole, zinc dibutyl-dithiocarbamate, dioctadecyl disulfide, pentaerythritol tetrakis-(β-dodecylmercapto)-propionate, N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N, N-dialkylhydroxylamine derived from hydrogenated tallow amine, N-benzyl-alpha-phenyl nitrone, N-ethyl-alpha-methyl nitrone, N-octyl-alpha-heptyl nitrone, N-lauryl-alpha-undecyl nitrone, N-tetradecyl-alpha-tridecyl nitrone, N-hexadecyl-alpha-pentadecyl nitrone, N-octadecyl-alpha-heptadecylnitrone, N-hexadecyl-alpha-heptadecyl nitrone, N-octadecyl-alpha-pentadecyl nitrone, N-heptadecyl-alpha-heptadecyl nitrone, N-octadecyl-alpha-hexadecyl nitrone, nitrone derived from N,N-dialkylhydroxylamine derived from hydrogenated tallow amine, dilauryl thiodipropionate or distearyl thiodipropionate, benzofuranones and indolinones, for example those disclosed in U.S. Pat. Nos. 4,325,863; 4,338,244; 5,175,312; 5,216,052; 5,252,643; 5,356,966; 5,367,008; 5,369,159; 5,428,162; 5,428,177; 5,488,117; 5,516,920; 5,607,624; 5,614,572; 5,693,829; 5,773,631; 5,814,692; 6,140,397; 6,521,681; 6,586,606; German Patent Nos. DE-A4316611, DE-A-4316622, DE-A4316876; and European Patent Nos. EP-A-0589839 and EP-A-0591102, 3-[4-(2-acetoxyethoxy)-phenyl]-5,7-di-tert-butylbenzofuran-2-one, 5,7-di-tert-butyl-3-[4-(2-stearoyloxyethoxy)phenyl]-benzofuran-2-one, 3,3′-bis[5,7-di-tert-butyl-3-(4-[2-hydroxyethoxylphenyl)benzofuran-2-one], 5,7-di-tert-butyl-3-(4-ethoxyphenyl)benzofuran-2-one, 3-(4-acetoxy-3,5-dimethylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 5,7-di-tert-butyl-3-phenyl-benzofuran-2-one, 5,7-di-tert-butyl-3-(3,4)-dimethylphenyl)-benzofuran-2-one, 5,7-di-tert-butyl-3-(2,3,4,5,6-pentamethyl)-benzofuran-2-one, 5-methyl-7-(octadec-2-yl)-3-(3,4-dimethylphenyl)-benzofuran-2-one, 5-methyl-7-(octadec-2-yl)-3-(2,3-dimethylphenyl)-benzofuran-2-one, 5-tert-butyl-7-(octadec-2-yl)-3-(3,4-dimethylphenyl)-benzofuran-2-one, 5-tert-butyl-7-(octadec-2-yl)-3-(2,3-dimethylphenyl)-benzofuran-2-one, 3-acetoxy-5,7-di-tert-butyl-3H-benzofuran-2-one, 5,7-di-tert-butyl-3-(2,5-dimethylphenyl)-3H-benzofuran-2-one, 5,7-di-tert-butyl-3-(4-methylthiophenyl)-3H-benzofuran-2-one, 5,7-di-tert-butyl-3-(4-methylphenyl)-3H-benzofuran-2-one, 5,7-di-tert-butyl-3-(9H-fluoren-3-yl)-3H-benzofuran-2-one, 3-phenyl-7-(1′-hexadecylethyl)-benzofuran-2-one, 2-amino-5,7-di-tert-butyl-3-(3,4-dimethylphenyl)-benzofuranone, 5,7-di-tert-butyl-3-(3,4-dimethoxyphenyl)-3H-benzofuran-2-one, 2-amino-5,7-di-tert-butyl-3-(3,4-dimethoxyphenyl)-benzofuranone, and mixtures thereof. The compositions of the present invention may include from about 0.01 to about 10.0 wt % of thermal stabilizers, or preferably from about 0.01 to about 5.0 wt %. More preferably, the compositions of the present invention contain from about 0.01 to about 1.0 wt % of thermal stabilizers. Most preferably, the compositions of the present invention contain from about 0.01 to about 0.3 wt % of thermal stabilizers.

It is understood that the ionoplast resin composition of the present invention may further comprise other additives such as plasticizers, colorants, processing aides, flow enhancing additives, lubricants, pigments, dyes, flame retardants, impact modifiers, nucleating agents, antiblocking agents such as silica, and the like. Examples of plasticizers, which may be added to improve processing, final mechanical properties, or to reduce rattle or rustle of the films and sheets of the present invention, include, but not limited to, stearic acid, oleic acid, soybean oil, epoxidized soybean oil, corn oil, caster oil, linseed oil, epoxidized linseed oil, mineral oil, alkyl phosphate esters, Tween® 20 plasticizers, Tween® 40 plasticizers, Tween® 60 plasticizers, Tween® 80 plasticizers, Tween® 85 plasticizers, sorbitan monolaurate, sorbitan monooleate, sorbitan monopalmitate, sorbitan trioleate, sorbitan monostearate, citrate esters, such as trimethyl citrate, triethyl citrate, (Citroflex® 2 plasticizer, produced by Morflex, Inc. Greensboro, N.C.), tributyl citrate, (Citroflex® 4 plasticizer, produced by Morflex, Inc., Greensboro, N.C.), trioctyl citrate, acetyltri-n-butyl citrate, (Citroflex® A-4 plasticizer, produced by Morflex, Inc., Greensboro, N.C.), acetyltriethyl citrate, (Citroflex® A-2 plasticizer, produced by Morflex, Inc., Greensboro, N.C.), acetyltri-n-hexyl citrate, (Citroflex® A-6 plasticizer, produced by Morflex, Inc., Greensboro, N.C.), and butyryltri-n-hexyl citrate, (Citroflex® B-6 plasticizer, produced by Morflex, Inc., Greensboro, N.C.), tartarate esters, such as dimethyl tartarate, diethyl tartarate, dibutyl tartarate, and dioctyl tartarate, poly(ethylene glycol), derivatives of poly(ethylene glycol), paraffin, monoacyl carbohydrates, such as 6-O-sterylglucopyranoside, glyceryl monostearate, Myvaplex® 600 plasticizer, (concentrated glycerol monostearates), Nyvaplex® plasticizer, (concentrated glycerol monostearate which is a 90% minimum distilled monoglyceride produced from hydrogenated soybean oil and which is composed primarily of stearic acid esters), Myvacet® plasticizer, (distilled acetylated monoglycerides of modified fats), Myvacet® 507 plasticizer, (48.5 to 51.5 percent acetylation), Myvacet® 707 plasticizer, (66.5 to 69.5 percent acetylation), Myvacet® 908 plasticizer, (minimum of 96 percent acetylation), Myverol® plasticizer, (concentrated glyceryl monostearates), Acrawax® plasticizer, N,N-ethylene bis-stearamide, N,N-ethylene bis-oleamide, dioctyl adipate, diisobutyl adipate, diethylene glycol dibenzoate, dipropylene glycol dibenzoate, polymeric plasticizers, such as poly(1,6-hexamethylene adipate), poly(ethylene adipate), Rucoflex® plasticizer, and other compatible low molecular weight polymers and mixtures thereof. Essentially any additive known within the art may find use in the present invention.

To aid in storage, processing or handling, ionomers of the present invention may also comprise an agent to prevent blocking. The use of anti-block agents or processing aids is optional in the practice of the present invention, but preferred. Conventional anti-blocking agents can be used, and one of ordinary skill in the art can determine whether such agents are desirable and at what level they should be used.

In another embodiment, the present invention is sheet or film obtained from the ionoplast resin of the present invention. A sheet or film of the present invention can be obtained, for example, by extruding the resin of the present invention using conventional or non-conventional means. Extrusion can be used to provide sheets of thickness ranging from about 0.38 to about 2.60 mm, or about 10 to about 200 mils, for example. To obtain films from a resin of the present invention, other conventional methods can be used, such as casting or blowing a film from the molten resin. For laminates of interest in the practice of the present invention, however, extrusion of an interlayer sheet is preferred. Extrusion of an interlayer of the present invention can be carried out at a temperature in the range of from about 175° C. to about 250° C. An interlayer sheet of the present invention can be extruded without a surface pattern, but it is preferred that an interlayer of the present invention have a surface pattern to facilitate the process of removing air or gaseous vapors from the interfacial spaces of the laminate as it is fabricated. The surface pattern can be applied either by known melt fracture techniques, or by use of an embossing tool, or by other conventional or non-conventional means. The optical clarity of an interlayer comprising a surface pattern is poor relative to the transparent laminate that is eventually obtained from the interlayer. The lamination process restores the optical clarity to the interlayer when the surface pattern is eliminated, for example when the interlayer is made to conform to other, smoother layers in the laminate.

In another embodiment, the present invention is a laminate prepared from a sheet comprising a resin of the present invention. In the glass laminating art, it is known that increased adhesion to glass can result in a laminate with diminished impact resistance. The resins of the present invention have improved adhesion but also have improved impact resistance. Without being held to any theory, it is believed that this property results from the lower melt index of the improved resins relative to the conventional resins. Adhesion to glass of the presently claimed resins, as measured by Double-Cantilever Beam (DCB) testing, is typically greater than 200 J/m² for laminates obtained using the presently claimed resins, and yet the resins exhibit impact toughness of greater than about 300 kJ/m². Preferably, the DCB adhesive strength is within the range of from about 200 to about 1200 J/m². Peel strength of laminates of the presently claimed invention is preferably greater than about 3 or about 6 lbs/inch.

Finding a proper balance between adhesion and the impact toughness in the manufacture of glass laminates comprising ionoplast resins is a goal of the present invention. Toughness of the laminate can be determined by measuring the impact toughness, particularly the impact penetration. The laminates of the present invention generally provide greater penetration resistance than conventional laminates.

Interlayers of the present invention can be laminated to glass or other transparent materials according to known or non-conventional methods. For example, an interlayer of the present invention can be assembled with at least one other laminate structural layer, such as glass, and laminated to the glass in an autoclave at a temperature above the softening point of the interlayer. Typically, for an ionoplast interlayer, the autoclave temperature can be at least about 120° C. Preferably the autoclave temperature is at least about 125° C., and more preferably at least about 130° C.

In another embodiment the present invention is a lamination process wherein a high acid resin can be laminated at a temperature of less than 120° C., preferably less than 110° C., to obtain a laminate wherein the adhesion of the laminate is at least as high as that in a laminate obtained from a conventional ethylene copolymer ionomer having less than about 20 wt % acid, and which requires lamination temperatures at or above 120° C. The possibility for relatively low temperature lamination provides for the development of alternate lamination processes, such as for example press-heating, pulse heating, or pass-through oven heating.

An interlayer suitable for use herein preferably comprises a surface pattern prior to lamination that facilitates removal of air or trapped vapors and gasses that may otherwise be trapped in the interface between the layers of the laminate. Vacuum or pressure can be applied to the laminate assembly to promote adhesion to glass and/or force out trapped gasses.

In another embodiment of the present invention, the lamination can be carried out at atmospheric pressure by application of heat and roll pressure from a nip roll, for example, or other mechanical pressure to the laminate assembly as it is heated. One of ordinary skill in the art of lamination will know how to carry out the lamination to obtain a laminate of the present invention by using the teachings of this application together with those known and practiced in the conventional art. The laminate thus obtained can be cooled to ambient temperatures at a cooling rate of at least about 5° F./min (2.78° C./min).

Laminates of the present invention can be constructed using multiple layers of interlayer of the present invention, or they can comprise interlayers or film layers of different chemical composition. For example, the interlayers of the present invention can be laminated together with other conventional interlayer materials such as, for example: conventional ionomeric interlayers can be laminated with the interlayers of the present invention, as can interlayers comprising EVA copolymers; polyurethanes; polyvinyl chloride polymers; or PVB. Laminates of the present invention can comprise adhesive layers to enhance adhesion between the polymeric layers and/or between polymer layers and glass. Conventional adhesives can be useful in the practice of the present invention as optional components. Typically, however, an interlayer of the present invention does not require an adhesive to promote adhesion to glass.

In another embodiment, surprisingly a laminate of the present invention having about 3% haze or less can be obtained by a process comprising a cooling step wherein the laminate is cooled at a rate of less than about 2.75° C./min. Further, the cooling rate of a laminate of the present invention can be slowed to less than about 2° C./min and a laminate having about 3% haze or less can be obtained, and even more surprising, the cooling rate can be slowed to less than 1° C./min to obtain a laminate having about 3% haze or less.

Laminates of the present invention are useful in applications such as: windows in buildings; windshields and sidelites in automobiles, planes, trains and the like; structural support units such as stairs, floors, walls, partitions; other architectural units such as ceilings. Laminates of the present invention can comprise at least one rigid structural layer that is adhered to at least one interlayer obtained from the improved resin composition of the present invention. Preferred are laminates comprising at least one interlayer of the present invention with at least one layer of glass as a rigid structural layer. Laminates of the present invention are particularly useful in applications where safety glass is desirable or required.

### EXAMPLES

The following Examples and comparative examples are presented to further illustrate the present invention. The Examples are not intended to limit the scope of the invention in any manner, nor should they be used to define the claims or specification in any manner that is inconsistent with the invention as claimed and/or as described herein.

### Example 1

### Test Methods

Haze was determined according to ASTM D1003, and is defined as the percentage of transmitted light that deviates from the incident by more than 2.5 degrees. Haze/Clarity measurements were obtained using a Byk-Gartner Haze-gard® Plus (HG Plus).

Melt Flow Index (MFI) was determined at 190° C. according to ISO 1133 and ASTM D1238.

Interlayer Toughness was determined according to ASTM 1822. This is a tensile impact method that determined the energy to rupture a polymer sheet at high rates of strain that are similar to the rates encountered during impact loading of a glass-interlayer laminate. Laminate Toughness was determined using a pendulum impact test. An impact test was performed on glass laminates to ascertain the impact energy required to penetrate the laminate (defined as the penetration energy). As a general guideline, a pendulum impactor defined by the Society of Automotive Engineers (SAE) Recommended Practice—J2568 ‘Intrusion Resistance of Safety Glazing System for Road Vehicles’ (generally believed by those in the industry to be reproducible and accurate) was used. The impactor mass was increased to 31.8-kg from 9.5-kg to allow smaller impact drop heights to be used. The pendulum was suspended on 6 cables (4-mm diameter) from a height of approximately 5.6 meters. The six-point cable suspension provides for an accuracy of ±5-mm of the desired impact point. The impactor is fabricated from steel into a 75-mm diameter hemispherical impacting end that was casehardened to prevent damage from repetitive impacts and glass shards. Samples were mounted into a rigid steel support structure allowing for impact perpendicular to the glass surface and preventing the edges of the samples from visibly moving in plane. The 30-cm square laminates were sandwiched between two steel frames with mating neoprene rubber gaskets peripherally holding the outer 22-mm of the laminate. Sufficient clamping was utilized to minimize any slippage of the sample within the supporting frame. Impacts were performed at a variety of impact energies on multiple sets of samples. The penetration energy was then calculated from the results based on a traditional ‘stair-case’ methodology used widely in the industry.

Laminates from the above impacted set were then submerged into a container of water at room temperature to check for the resiliency and hydrolytic stability of the retention of glass to the interlayer under potentially adverse environmental conditions. The higher percent acid containing interlayers show greater retention of glass fragments after breakage than the lower acid counterparts.

Laminates were peeled at either a 90-degree or a 180-degree angle using an INSTRUMENTORS, Inc., Model SP-102B-3M90 SLIP/PEEL Tester. The laminates were peeled at a rate of 25.4 mm (1 inch) per minute. Peel strength data shown in Table 1 were acquired on laminates made from interlayer sheets that were hot press molded. Peel strength data shown in Table 3 were acquired on laminates made from extruded interlayer sheets.

Glass laminates were prepared by the following method. Sheets of annealed glass 300 mm square by 3-mm thickness were washed with a solution of trisodium phosphate (5 g/liter) in deionized water and then rinsed thoroughly with deionized water and dried. Various polymeric interlayers (see Table 1, below) having a thickness of 0.76 mm were placed on top of the bottom piece of glass. A second lite of similar glass was then placed over this polymer sheet. The preassembly was then held in register by taping together with a few pieces of polyester tape around the periphery to maintain relative positioning of each layer. A nylon fabric strip was then placed around the periphery of the preassembly to facilitate air removal from within the layers. The preassembly was then placed inside a nylon vacuum bag and connected to a vacuum pump. A vacuum was applied to allow substantial removal of air from within (air pressure inside the bag was reduced to below 50 millibar absolute). The prelaminate assembly was then placed into an air autoclave and the pressure and temperature was increased from ambient to 135° C. and 200 psi in a period of 15 minutes. This temperature and pressure was then held for a sufficient period of time to allow the laminate assembly to heat properly (in this case 30 minutes). Next the temperature was decreased to 40° C. within a 20-minute period, 60-minute period or 120-minute period whereby the pressure was then dropped back to ambient and the laminated unit was removed. After autoclaving the laminates were cleaned thoroughly and the haze measured. The determined values are reported in Table 1 below.

Several sheets of an interlayer obtained from resin having 21 wt % of methacrylic acid were laminated to glass at either 105° C. or 135° C. in an autoclave. The sheets had moisture content as indicated in Table 2, and the laminates were tested for 180° peel strength.

TABLE 1

| | | wt % Acid | 90° Peel | | | | |
|---|---|---|---|---|---|---|---|
| | | in | Strength | % | Haze | | |
| Sample # | MI Base | Copolymer | (lb/inch)^{a} | Neutralization | 20 min | 60 min | 120 min |
| C1 | 29.1 | 21.5 | ND¹ | 14.1 | 2.42 | 2.83 | 4.96 |
| C2 | 29.1 | 21.5 | 27.8 | 17.1 | 2.42 | 2.50 | 3.82 |
| C3 | 29.1 | 21.5 | 26.1 | 17.9 | 2.28 | 2.54 | 3.56 |
| 1 | 29.1 | 21.5 | 17.0 | 22.1 | 1.88 | 2.18 | 3.07 |
| 2 | 29.1 | 21.5 | 2.4 | 22.4 | 1.78 | 2.01 | 2.98 |
| 3 | 29.1 | 21.5 | 11 | 24 | 1.28 | 1.50 | 2.96 |
| 4 | 29.1 | 21.5 | 14.7 | 28.7 | 1.33 | 1.48 | 2.85 |
| 5 | 29.1 | 21.5 | 11.1 | 28.9 | 1.08 | 1.01 | 1.87 |
| 6 | 29.1 | 21.5 | 11.4 | 31.1 | 1.03 | 0.89 | 1.19 |
| 7 | 29.1 | 21.5 | 12.0 | 32.5 | 0.74 | 0.74 | 1.09 |
| 8 | 29.1 | 21.5 | 4.6 | 34.5 | 0.80 | 0.79 | 0.81 |
| C4 | 60 | 21.5 | 18.4 | 24.8 | 4.02 | 4.73 | 6.18 |
| C5 | 60 | 21.5 | 6.5 | 26 | 4.10 | 4.71 | 6.18 |
| C6 | 60 | 21.5 | 8.7 | 28.7 | 3.52 | 3.55 | 4.67 |
| C7 | 60 | 21.5 | 9.4 | 30.3 | 2.75 | 3.13 | 4.26 |
| 9 | 60 | 21.5 | 8.0 | 32.8 | 2.08 | 2.19 | 2.98 |
| 10 | 60 | 21.5 | 7.2 | 35.3 | 1.76 | 1.72 | 2.28 |
| 11 | 60 | 21.5 | 9.6 | 37.3 | 1.27 | 1.19 | 1.63 |
| 12 | 60 | 21.5 | 5.2 | 39.7 | 1.22 | 1.19 | 1.48 |
| 13 | 60 | 21.5 | 4.8 | 41.1 | 1.62 | 1.04 | 1.56 |
| 14 | 60 | 21.5 | 4.7 | 43.8 | 1.01 | 0.99 | 1.08 |
| C9 | 60 | 21.5 | 3.9 | 47.5 | 0.90 | 0.92 | 1.04 |
| C10 | 60 | 19 | 5.7 | 37 | 1.57 | 1.64 | 4.76 |
| C11 | 60 | 19 | 6.5 | 36.8 | 1.08 | 1.16 | 3.38 |
| C12 | 60 | 19 | | 37 | 1.02 | 1.35 | 3.98 |

^{a}Peel done at rate of 1 inch per minute.
¹Adhesion not determined - interlayer tore rather than pulled away from glass.

TABLE 2

| | | | | 180° Peel |
|---|---|---|---|---|
| | | Moisture | Lamination | Strength |
| Sample # | Wt % acid | (wt %) | Temp (° C.) | (lb/inch) |
| C10 | 19 | 0.066 | 105 | 2.7 |
| 15 | 21.5 | 0.054 | 105 | 19.3 |
| 16 | 21.5 | 0.494 | 105 | 9 |
| 17 | 21.5 | 0.054 | 135 | 22.6 |
| C10 | 19 | 0.066 | 135 | 3.5 |
| C11 | 19 | 0.407 | 135 | <0.3 |

TABLE 3

| | | | | | Tensile |
|---|---|---|---|---|---|
| | | | | 90-degree Peel | Impact |
| | MI Base Resin | wt % Acid in | | Strength | Energy, |
| Sample # | (g/10 min) | Co-polymer | % Neutralization | (lb/inch) | kJ/m² |
| C1 | 29.1 | 21.5 | 14.1 | 50.0 | 347 |
| C2 | 29.1 | 21.5 | 17.1 | — | 418 |
| C3 | 29.1 | 21.5 | 17.9 | 45.3 | 404 |
| 1 | 29.1 | 21.5 | 22.1 | 38.3 | 398 |
| 2 | 29.1 | 21.5 | 22.4 | 46.7 | 374 |
| 3 | 29.1 | 21.5 | 24 | 23.9 | 452 |
| 4 | 29.1 | 21.5 | 28.7 | 18.1 | 479 |
| 5 | 29.1 | 21.5 | 28.9 | 26.1 | 511 |
| 6 | 29.1 | 21.5 | 31.1 | 19.2 | 517 |
| 7 | 29.1 | 21.5 | 32.5 | 28.8 | 548 |
| 8 | 29.1 | 21.5 | 34.5 | 20.3 | 672 |
| C4 | 60 | 21.5 | 24.8 | 18.6 | — |
| C5 | 60 | 21.5 | 26 | 7.1 | 380 |
| C6 | 60 | 21.5 | 28.7 | 21.5 | 418 |
| C7 | 60 | 21.5 | 30.3 | 15.5 | 413 |
| 9 | 60 | 21.5 | 32.8 | 15.8 | 438 |
| 10 | 60 | 21.5 | 35.3 | 8.4 | 532 |
| 11 | 60 | 21.5 | 37.3 | 5.4 | 455 |
| 12 | 60 | 21.5 | 39.7 | 5 | 543 |
| C4 | 60 | 21.5 | 41.1 | 5.3 | 520 |
| C5 | 60 | 21.5 | 43.8 | 4.1 | 505 |
| C6 | 60 | 21.5 | 47.5 | 3.1 | — |
| C7 | 60 | 19 | 37 | 6.2 | 323 |
| C8 | 60 | 19 | 36.8 | 9.1 | 488 |
| C9 | 60 | 19 | 37 | 9.7 | — |

TABLE 4
Glass/Polymer Laminate Pendulum Impact Properties

| | | | | Penetration Energy |
|---|---|---|---|---|
| Sample # | % Acid | MI Base | % Neutralization | (Joules) |
| 1 | 19.0 | 60.0 | 37.0 | 304 |
| 2 | 21.5 | 29.1 | 24.0 | 324 |
| 3 | 21.5 | 29.1 | 28.7 | 332 |
| 4 | 21.5 | 29.1 | 28.9 | 313 |

TABLE 5
Glass Loss After Pendulum Impact Test

| | | | | Glass |
|---|---|---|---|---|
| Sample # | % Acid | MI Base | % Neutralization | Loss (gms.) |
| 1 | 19.0 | 60.0 | 37.0 | 64 |
| 2 | 21.5 | 29.1 | 24.0 | 27 |
| 3 | 21.5 | 29.1 | 28.7 | 36 |
| 4 | 21.5 | 29.1 | 28.9 | 27 |

### Hurricane Impact Tests

For architectural uses in coastal areas, a glass/interlayer/glass laminate must pass a simulated hurricane impact and cycling test which measures resistance of the laminate to debris impact and wind pressure cycling. A currently acceptable test is performed in accordance to the South Florida Building Code Chapter 23, section 2315 Impact tests for wind born debris. Fatigue load testing is determined according to Table 23-F of section 2314.5, dated 1994. This test simulates the forces of the wind plus airborne debris impacts during severe weather, e.g., a hurricane.

The test consists of two impacts on the laminate (one in the center of the laminate sample followed by a second impact in a corner of the laminate). The impacts are done by launching a 9-pound (4.1 kilograms) board nominally 2 inches (5 cm) by 4 inches (10 cm) and 8 feet (2.43 meters) long at 50 feet/second (15.2 meters/second) from an air pressure cannon. If the laminate survives the above impact sequence, it is subjected to an air pressure cycling test. In this test, the laminate is securely fastened to a chamber. In the positive pressure test, the laminate with the impact side outward is fastened to the chamber and a vacuum is applied to the chamber and then varied to correspond with the cycling sequences set forth in the following Table A. The pressure cycling schedule, as shown in Table A below, is specified as fraction of a maximum pressure P. Each cycle of the first 3500 cycles and subsequent cycles is completed in about 1-3 seconds. On completion of the positive pressure test sequence, the laminate is reversed with the impact side facing inward to the chamber for the negative pressure portion of the test and a vacuum is applied corresponding to the following cycling sequence. The values are expressed as negative values (−).

TABLE A

| | | |
|---|---|---|
| | | Pressure Range [pounds per |
| | | square foot (Pascals)] |
| Number of Air | Pressure | Example given for 70 psf |
| Pressure Cycles | Schedule* | (3352 Pascals) |

Positive Pressure (inward acting)

| | | |
|---|---|---|
| 3,500 | 0.2 P to 0.5 P | 14 to 35 (672–1680 Pascals) |
| 300 | 0.0 P to 0.6 P | 0 to 42 (0–2016 Pascals) |
| 600 | 0.5 P to 0.8 P | 35 to 56 (1680–2688 Pascals) |
| 100 | 0.3 P to 1.0 P | 21 to 70 (1008–3360 Pascals) |

Negative Pressure (outward acting)

| | | |
|---|---|---|
| 50 | −0.3 P to −1.0 P | −21 to −70 (−1008 to −3360 |
| | | Pascals) |
| 1,060 | −0.5 P to −0.8 P | −35 to −56 (−1680 to −2688 |
| | | Pascals) |
| 50 | 0.0 P to −0.6 P | −0 to −42 (0 to −2016 Pascals) |
| 3,350 | −0.2 P to −0.5 P | −14 to −35 (−672 to −1680 |
| | | Pascals) |

*Absolute pressure level where P is 70 pounds per square foot (3360 Pascals).

A laminate passes the impact and cycling test when there are no tears or openings over 5 inches (12.7 cm) in length and not greater than 1/16 inch (0.16 cm) in width.

Glass laminates used in the hurricane impact tests are prepared in the following manner: All laminates used a 90 mil (2.3 mm) thick interlayer of an ionomer resin (Type ‘A’) composed of 81% ethylene, 19% methacrylic acid, 37% neutralized with sodium ion and having a final melt index around 2.6 or (Type ‘B’) composed of 78.5% ethylene, 21.5% methacrylic acid, 32% neutralized with sodium ion and having a final melt index around 0.9. The interlayer was sandwiched between two layers of glass as described below. The ionomer resin interlayer has a Storage Young's Modulus of about 361 MPa.

All laminates are prepared by placing the interlayer between the glass panels. Each of the glass panels is washed with deionized water. The laminates are placed in an air autoclave at 220 PSIG (1.6 MPa) pressure at 135° C. for 30 minutes. The laminates for the impact testing are 30 inches (77.2 cm) high by 48 inches (121.9 cm) wide. Laminates were then glued into an aluminum frame glazed with a silicone sealant (Dow Corning type 995). This frame was then mounted into a steel supporting frame to conduct the impact test in such a way to minimize movement of the overall glazing. The laminates tested and displayed in Table 6 were impact tested to measure the impact ‘toughness’ against the timber missile at increased velocities. The laminates of Table 7 were first tested according to the Florida impact and the then subjected to the air pressure cycling test sequence. In the impact test a missile of a 9-pound (4.1 kilograms) pine board nominally 2 inches (5 cm) by 4 inches (10 cm) and 8 feet (2.43 meters) long is propelled against the laminate at 50 feet/second (15.2 meters/second) from an air pressure cannon striking the laminate “normal” to its surface. Each of the laminates is subjected to two impacts in two different locations of the laminate, which fractures the glass. The impacts in the center of the laminate were conducted in the standard way (velocity around 50 fps) whereas the velocity of the corner impact was varied to measure the impact ‘toughness’ of the glazing. The results of the test are shown below in Table 6 below.

Additional samples were prepared in a larger size (1.52-m×2.44-m w/two lites 6 mm Heat-Strengthened Glass laminated with 2.28 mm Ionomer Interlayer) and glazed into a Commercial Aluminum Framing System using silicone sealant and 26 mm glazing overlap to frame. The impacts, both center and corner, were performed at the prescribed 50 fps missile velocity without creating any tears. The air-pressure cycling sequence was then performed to simulate hurricane force wind stressing and flexing of the glazing panels. The results are provided in Table 7.

TABLE 6

| | Laminated Ionomer Resin | | | |
|---|---|---|---|---|
| | IMPACT TEAR LENGTH | | | |
| | (cm) VELOCITIES (feet per second) | | | |
| Interlayer Type | 50 fps | 55 fps | 60 fps | 65 fps |
| Ionomer ‘A’ | 0 | 12.1 | 15.3 | 29.8 |
| Base Resin MI 60 | | | | |
| 19% Acid in Copolymer | | | | |
| 37% Neutralization | | | | |
| Ionomer ‘B’ | 0 | 0 | 10.2 | 27.3 |
| Base Resin MI 30 | | | | |
| 21.5% Acid in Copolymer | | | | |
| 32% Neutralization | | | | |

Laminated samples were 77.2 cm × 121.9 cm, Interlayer thickness: 2.28 mm

TABLE 7
AIR PRESSURE CYCLING SEQUENCE

| | POSITIVE | | | | | |
|---|---|---|---|---|---|---|
| | PRESSURE INWARD | | | NEGATIVE PRESSURE | | |
| | ACTING | | | OUTWARD ACTING | | |
| | Pressure | | | Pressure | | |
| | (lbs/ft²) | Cycles | Result | (lbs/ft²) | Cycles | Result |
| Ionomer ‘A’ | 100 | 4500 | Passed | 100 | <18 | Failed |
| Ionomer ‘B’ | 100 | 4500 | Passed | 100 | 4500 | Passed |
| Ionomer | 125 | 4500 | Passed | 125 | 4500 | Passed |
| ‘B’ | | | | | | |

Laminated samples were 1.52-m × 2.44-m w/two lites 6 mm Heat-Strengthened Glass laminated with 2.28 mm Ionomer Interlayer glazing into a Commercial Aluminum Framing System using silicone sealant and 26 mm glazing overlap to frame.

### Example 2

The compositions set forth below in Table 8 were dry blended and then compounded on a 1 inch Killion single screw extruder. The weight percentages in Table 8 are based on the total weight of the final composition. Polymer A is poly(ethylene-co-methacrylic acid) with 15 wt % of methacrylic acid, 59% neutralized with sodium, and a MI of 0.9. Polymer B is poly(ethylene-co-methacrylic acid) with 21.4 wt % of methacrylic acid, 29% neutralized with sodium, and a MI of 0.9. Polymer C is poly(ethylene-co-methacrylic acid) with 21.4 wt % of methacrylic acid, 32% neutralized with zinc, and a MI of 1.3. Polymer D is poly(ethylene-co-methacrylic acid) with 19 wt % of methacrylic acid, 37% neutralized with sodium, and a MI of 2.0. Polymer E is poly(ethylene-co-methacrylic acid) with 10 wt % of methacrylic acid, 55% neutralized with sodium, and a MI of 1.3. Polymer F is poly(ethylene-co-methacrylic acid) with 20 wt % of methacrylic acid, 35% neutralized with sodium, and a MI of 2.6.

Chimassorb® 119 FL stabilizer is reported to be 1,5,8,12-tetrakis[4,6-bis(N-butyl-N-1,2,2,6,6-pentamethyl-4-piperidylamino)-1,3,5-triazin-2-yl]-1,5,8,12-tetraazadodecane, (CAS Number 106990-43-6). Tinuvin® 770 stabilizer is reported to be bis(2,2,6,6-tetramethyl-4-piperidyl)sebacate, (CAS Number 52829-07-9). Tinuvin® 123 stabilizer is reported to be bis(1-octyloxy-2,2,6,6-tetramethyl-4-piperidyl)sebacate, (CAS Number 129757-67-1). Chimassorb® 944 FD stabilizer is reported to be poly[[6-[(1,1,3,3-tetramethylbutyl)amino]-s-triazine-2,4-diyl]-[(2,2,6,6-tetramethyl-4-piperidyl)imino]-hexamethylene-[(2,2,6,6-tetramethyl-4-piperidylimino]], (CAS Number 71878-19-8). Irganox® HP 2215 FF stabilizer is reported to be a 2:4:1 (by weight) blend of Irganoxe 1010:Irgafos® 168:HP-136. Irganox® 1010 stabilizer is reported to be pentaerythritol tetrakis(3,5-di-tert-butyl-4-hydroxyhydrocinnamate), (CAS Number 6683-19-8). Irgafos® 168 stabilizer is reported to be tris(2,4-di-tert-butylphenyl)phosphite, (CAS Number 31570-044). HP-136® stabilizer is reported to be 5,7-di-tert-butyl-3-(3,4-di-methylphenyl)-3H-benzofuran-2-one, (CAS Number 181314-48-7). Cyasorb® UV-5411 stabilizer is reported to be 2-(2-hydroxy-5-tert-octylphenyl)benzotriazole.

Cyasorb® 3346 stabilizer is reported to be poly[(6-morpholino-s-triazine-2,4-diyl)[2,2,6,6-tetramethyl-4-piperidyl)imino]-hexamethylene[(2,2,6,6-tetramethyl-4-piperidyl)imino]]. Tinuvin® 1577 stabilizer is reported to be 2-(4,6-diphenyl-1,3,5-triazin-2-yl)-5-[(hexyl)oxy]-phenol, (CAS Number 147315-50-2). Tinuvin® 328 stabilizer is reported to be 2-(2H-benzotriazol-2-yl)-4,6-di-tert-pentylphenol, (CAS Number 25973-55-1). Tinuvin® 360 stabilizer is reported to be 2,2′-methylenebis[6-(2H-benzotriazol-2-yl)-4-(1,1,3,3-tetramethylbutyl)phenol], (CAS Number 103597-45-1). Irganox® 3114 stabilizer is reported to be tris(3,5-di-tert-butyl-4-hydroxybenzyl)isocyanurate, (CAS Number 27676-62-6). Tinuvin® 234 stabilizer was reported to be 2-(2H-benzotriazol-2-yl)-4,6-bis(1-methyl-1-phenylethyl)phenol, (CAS Number 70321-86-7). Tinuvin® 326 stabilize was reported to be 2-(3-tert-butyl-2-hydroxy-5-methylphenyl)-5-chloro-2H-benzotriazole, (CAS Number 3896-11-5). Cyasorb® UV-531 stabilizer was reported to be 2-hydroxy-4-n-octoxybenzophenone, (CAS Number 1843-05-6).

The Tinuvin™, Chimassorb™, Irganox™, Irgafos™ and HP-136 product lines are available from Ciba Specialty Chemicals of Basel, Switzerland, whose North American headquarters are in Tarrytown, N.Y. Cyasorb™ products are available from Cytec Industries, Inc. of West Paterson, N.J.; they were formerly available from the American Cyanamid Co.

The extruder had a melt temperature of approximately 200° C. and a rate of 2.5 pounds per hour. The screw speed ranged from 47 to 70 RPM and the rear zone temperature ranged from 120° C. to 170° C., depending on the composition. The adapter pressure ranged from 400 psi to 800 psi and power consumption ranged from about 2.5 to 3 amps. The typical extruder barrel temperature profile was as follows;
Rear (Feed Hopper) Zone: 120 to 170° C.
Mid Zone: 199 to 203° C.
Front Zone: 200 to 202° C.
Adapter: 200 to 201° C.
   A single strand was passed through a water bath and pelletized to form small pellets. The pellets were purged with nitrogen overnight at room temperature and then sealed in a moisture barrier package.

TABLE 8

| | Composition |
|---|---|
| Sample # | (wt %) |
| C1 | 99.50 Polymer A |
| | 0.25 Chimassorb ® 119 FL |
| | 0.25 Tinuvin ® 770 |
| 1 | 99.50 Polymer B |
| | 0.25 Chimassorb ® 119 FL |
| | 0.25 Tinuvin ® 770 |
| 2 | 99.90 Polymer B |
| | 0.10 Tinuvin ® 123 |
| 3 | 99.70 Polymer C |
| | 0.30 Chimassorb ® 944 FD |
| C2 | 98.90 Polymer D |
| | 1.00 Chimassorb ® 944 FD |
| | 0.10 Irganox ® HP 2215 FF |
| 4 | 98.90 Polymer B |
| | 1.00 Chimassorb ® 944 FD |
| | 0.10 Irganox ® HP 2215 FF |
| 5 | 99.70 Polymer B |
| | 0.10 Chimassorb ® 119 FL |
| | 0.10 Tinuvin ® 770 |
| | 0.10 Irgafos ® 168 |
| C3 | 99.00 Polymer E |
| | 0.50 Cyasorb ® UV-5411 |
| | 0.50 Cyasorb ® 3346 |
| 6 | 99.00 Polymer B |
| | 0.50 Cyasorb ® UV-5411 |
| | 0.50 Cyasorb ® 3346 |
| 7 | 99.50 Polymer B |
| | 0.25 Tinuvin ® 1577 |
| | 0.25 Tinuvin ® 123 |
| 8 | 99.90 Polymer B |
| | 0.05 Tinuvin ® 328 |
| | 0.05 Chimassorb ® 944 FD |
| 9 | 99.30 Polymer B |
| | 0.30 Tinuvin ® 360 |
| | 0.30 Chimassorb ® 119 FL |
| | 0.10 Irganox ® 3114 |
| C4 | 99.70 Polymer A |
| | 0.30 Tinuvin ® 234 |
| 10 | 99.70 Polymer B |
| | 0.30 Tinuvin ® 234 |
| 11 | 99.40 Polymer B |
| | 0.60 Tinuvin ® 1577 |
| 12 | 99.70 Polymer B |
| | 0.30 Tinuvin ® 360 |
| C5 | 99.60 Polymer A |
| | 0.30 Tinuvin ® 326 |
| | 0.10 Irganox ® 1010 |
| 13 | 99.60 Polymer B |
| | 0.30 Tinuvin ® 326 |
| | 0.10 Irganox ® 1010 |
| 14 | 99.55 Polymer B |
| | 0.15 Cyasorb ® 531 |
| | 0.20 Irganox ® 3114 |
| | 0.10 Irgafos ® 168 |
| 15 | 99.60 Polymer C |
| | 0.30 Tinuvin ® 328 |
| | 0.10 HP-136 ® |

Plaques (6 inch by 7 inch (152 mm×178 mm) by 25 mil thick) were produced for comparative samples C1-5 and samples 1-15 through compression molding on a Carver Melt Press. The compression molding was conducted at a temperature of 190° C. and a pressure of 20,000 psi. The plaques were cooled to room temperature over approximately 30 minutes. The plaques were then packaged in moisture barrier packaging.

Laminates composed of a glass layer and a 25 mil thick interlayer from the plaques for comparative samples C1-5 and samples 1, 4, 6,10, 11, and 13-15 produced above were produced in the following manner. The 6 inch by 7 inch, (152 mm×178 mm), 25 mil thick sheet produced as described above was placed onto a 12 inch by 12 inch, (305 mm×305 mm), by 2.5 mm thick annealed float glass plate. A thin Teflon® film was placed on top of the polymeric interlayer and a cover glass plate was placed on top of the thin Teflon® film. The glass/interlayer/Teflon® film/glass assembly was then placed into a vacuum bag and heated to 90-100° C. for 30 minutes to remove any air contained between the glass/interlayer assembly. The glass/interlayer pre-press assembly was then subjected to autoclaving at 135° C. for 30 minutes in an air autoclave to a pressure of 200 psig, (14.3 bar), as described above. The air is then cooled while no more air is added to the autoclave. After 20 minutes of cooling when the air temperature is less than about 50° C., the excess pressure is vented, and the glass/interlayer laminate is removed from the autoclave.

These glass laminates were subjected to 90 degree peel strength adhesion testing with the results reported below within Tables 9 and 10. The laminates were peeled at a 90-degree angle using an INSTRUMENTORS, Inc., Model SP-102B-3M90 SLIP/PEEL Tester. The laminates were peeled at rates of 1 inch and 2 inches per minute.

TABLE 9

| | 90 Degree Peel Strength |
|---|---|
| Sample # | (lb/inch) |
| C1 | 0.7 ± 0.07 |
| 1 | 4.0 ± 0.4 |
| C2 | 5.6 ± 0.5 |
| 4 | 13.1 ± 1.4 |
| C3 | 0.4 ± 0.1 |
| 6 | 8.7 ± 0.5 |

TABLE 10

90 Degree Peel Strength
(lb/inch)
Peel Rate

| Sample # | 1 inch/min. | 2 inches/min. |
|---|---|---|
| C4 | 0.6 | 0.5 |
| 10 | 2.0 | 1.4 |
| 11 | 1.4 | 1.3 |
| C5 | 1.3 | 0.6 |
| 13 | 1.5 | 1.5 |
| 14 | 1.8 | 1.8 |
| 15 | 9.2 | 10.1 |

These results demonstrate that the polymeric interlayers produced from the ionoplast resin of the present invention are highly adhesive.

While certain of the preferred embodiments of the present invention have been described and specifically exemplified above, it is not intended that the invention be limited to such embodiments. Various modifications may be made without departing from the scope and spirit of the present invention, as set forth in the following claims.

What is claimed is:

1. A resin composition comprising an ethylene acid copolymer, wherein said ethylene acid copolymer comprises residues of ethylene and from about 20.5 to about 30 wt % of residues of carboxylic acids selected from the group consisting of α,β-unsaturated acids having from 3 to 8 carbons, and wherein from about 10% to about 90% of the carboxylic acids are neutralized.

2. The resin composition of claim 1 which has a melt index of about 60 g/10 min or less prior to neutralization.

3. The resin composition of claim 1, wherein said ethylene acid copolymer comprises from about 21 to about 25 wt % of carboxylic acids selected from the group consisting of α,β-unsaturated acids having from 3 to 8 carbons.

4. The resin composition of claim 1, wherein said ethylene acid copolymer comprises from about 21 to about 23 wt % of carboxylic acids selected from the group consisting of α,β-unsaturated acids having from 3 to 8 carbons.

5. The resin composition of claim 1, wherein the ethylene acid copolymers of the present invention are from about 15 to about 45% neutralized.

6. The resin composition of claim 1, wherein the ethylene acid copolymers of the present invention are from about 20 to about 35% neutralized.

7. The resin composition of claim 1, further comprising at least one additive selected from the group consisting of hindered amine light stabilizers (HALS), ultraviolet (UV) light absorbers, and thermal stabilizers.

8. The resin composition of claim 7, wherein said at least one additive is a thermal stabilizer.

9. The resin composition of claim 8, further comprising at least one other additive selected from the group consisting of HALS and UV light absorbers.

10. The resin composition of claim 8, further comprising at least one HALS and at least one UV light stabilizer.

11. The resin composition of claim 7, wherein said at least one additive is an UV light absorber.

12. The resin composition of claim 11, further comprising at least one HALS.

13. The resin composition of claim 7, wherein said at least one additive is a HALS.

14. The resin composition of claim 7, wherein said at least one additive is present in the amount of about 0.01 to about 10.0 wt %, based on the total weight of the resin composition.

15. The resin composition of claim 7, wherein said at least one additive is present in the amount of about 0.01 to about 5.0 wt %, based on the total weight of the resin composition.

16. The resin composition of claim 7, wherein said at least one additive is present in the amount of about 0.01 to about 1.0 wt %, based on the total weight of the resin composition.

17. The resin composition of claim 7, wherein said at least one additive is present in the amount of about 0.01 to about 0.5 wt %, based on the total weight of the resin composition.

18. A shaped article comprising a resin composition which comprises an ethylene acid copolymer, wherein said ethylene acid copolymer comprises residues of ethylene and from about 20 to about 30 wt % of residues of carboxylic acids selected from the group consisting of α,β-unsaturated acids having from 3 to 8 carbons, and wherein from about 10% to about 90% of the carboxylic acids are neutralized.

19. The shaped article of claim 18, wherein said resin composition further comprises at least one additive selected from the group consisting of hindered amine light stabilizers (HALS), ultraviolet (UV) light absorbers, and thermal stabilizers.

20. A multilayer film or sheet comprising at least one layer derived from a resin composition which comprises an ethylene acid copolymer, wherein said ethylene acid copolymer comprises residues of ethylene and from about 20 to about 30 wt % of residues of carboxylic acids selected from the group consisting of α,β-unsaturated acids having from 3 to 8 carbons, and wherein from about 10% to about 90% of the carboxylic acids are neutralized.

21. The multilayer film or sheet of claim 20, wherein said resin composition further comprises at least one additive selected from the group consisting of hindered amine light stabilizers (HALS), ultraviolet (UV) light absorbers, and thermal stabilizers.

22. A transparent interlayer comprising the shaped article of claim 18.

23. A transparent interlayer comprising the shaped article of claim 19.

24. A laminate article comprising at least one shaped article of claim 18.

25. A laminate article comprising at least one shaped article of claim 19.

26. A process for preparing a transparent laminate article having a haze of about 3% or less, comprising the steps of:
(a) extruding at a temperature of from about 175° C. to about 250° C. a shaped article of claim 18; and
(b) fabricating a laminate from the interlayer by (1) setting up the interlayer and at least one other laminate layer to form a pre-laminate assembly and (2) heating the pre-laminate assembly to a temperature of at least about 120° C. and applying pressure or vacuum to the assembly for a period of time and (3) cooling the laminate to obtain the transparent laminate.

27. The process of claim 26, wherein the laminate is cooled at a rate of 2.75 ° C./min or less.

28. A process for preparing a transparent laminate article having a haze of about 3% or less, comprising the steps of:
(a) extruding at a temperature of from about 175° C. to about 250° C. a shaped article of claim 19; and
(b) fabricating a laminate from the interlayer by (1) setting up the interlayer and at least one other laminate layer to form a pre-laminate assembly and (2) heating the pre-laminate assembly to a temperature of at least about 120° C. and applying pressure or vacuum to the assembly for a period of time and (3) cooling the laminate to obtain the transparent laminate.

29. The process of claim 28, wherein the laminate is cooled at a rate of 2.75 ° C./min or less.
